(19) United States
(12) Patent Application Publication
(10) Pub. No.: US 2025/0386397 A1
(43) Pub. Date: Dec. 18, 2025

(54) METHOD AND APPARATUS FOR MANAGING MULTICAST BROADCAST SERVICE SESSION IN A WIRELESS COMMUNICATION SYSTEM

(71) Applicant: SAMSUNG ELECTRONICS CO., LTD., Suwon-si, Gyeonggi-do (KR)

(72) Inventors: Vinay Kumar SHRIVASTAVA, Bangalore (IN); Sriganesh RAJENDRAN, Bangalore (IN); Aby KANNEATH ABRAHAM, Bangalore (IN)

(21) Appl. No.: 18/879,195

(22) PCT Filed: Jun. 27, 2023
(86) PCT No.: PCT/KR2023/008960

§ 371 Date: Dec. 26, 2024

(30) Foreign Application Priority Data
Jun. 28, 2022 (IN) 202241036925
May 26, 2023 (IN) 202241036925

(51) Int. Cl. H04W 76/40; H04W 68/02; H04W 76/27

(52) U.S. Cl. CPC H04W 76/40; H04W 68/02; H04W 76/27

(57) ABSTRACT

The disclosure relates to a 5G or 6G communication system for supporting a higher data transmission rate. Specifically, the disclosure related to method performed by a user equipment (UE) in a wireless communication system. The method includes receiving, from a base station (BS), a radio resource control (RRC) release message including a suspend configuration, the RRC release message including configuration information for a reception of a multicast session in an RRC inactive state. Further, the method includes receiving, from the BS while the UE is in the RRC inactive state, a first group paging message indicating an activation of the multicast session based on the configuration information. Further, the method includes receiving, from the BS while the UE is in the RRC inactive state, a multicast of the multicast session based on the configuration information.

### TECHNICAL FIELD

The present disclosure generally relates to wireless communication system and, more specifically, the present disclosure relates to method and apparatus for managing one or more Multicast Broadcast Service (MBS) multicast sessions in a User Equipment (UE) in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The present disclosure relates to wireless communication systems and, more specifically, the present disclosure relates to method and apparatus for managing one or more Multicast Broadcast Service (MBS) multicast sessions in a User Equipment (UE) in a wireless communication system.

### Solution to Problem

According to one embodiment of the present disclosure, a method for managing one or more multicast broadcast service (MBS) multicast sessions in a user equipment (UE) is disclosed. The method includes receiving, by the UE, a group notification message for the one or more MBS multicast sessions. The group notification message includes at least one of an identity corresponding to at least one of the one or more MBS multicast sessions, a session status, an indication of Radio Resource Control (RRC) state, a congestion status, and a change of MBS multicast session configuration. Further, the method includes changing at least one of a session status of the one or more MBS multicast sessions, the RRC state and the MBS multicast session configuration of the UE based on the received group notification message.

According to one embodiment of the present disclosure, a method for managing one or more multicast broadcast service (MBS) multicast sessions in a plurality of user equipment (UE) is disclosed. The method includes transmitting, by a network, a group notification message to the plurality of UEs for the one or more MBS multicast sessions. The group notification message includes at least one of an identity corresponding to at least one of the one or more MBS multicast sessions, a session status, an indication of Radio Resource Control (RRC) state, a congestion status and a change of MBS multicast session configuration.

According to another embodiment of the present disclosure, a user equipment (UE) for managing one or more multicast broadcast service (MBS) multicast sessions is disclosed. The UE is configured to receive a group notification message for the one or more MBS multicast sessions. The group notification message includes at least one of an identity corresponding to at least one of the one or more MBS multicast sessions, a session status, an indication of Radio Resource Control (RRC) state, a congestion status and a change of MBS multicast session configuration. Further, the UE is configured to change at least one of a session status of the one or more MBS multicast sessions, the RRC state and the MBS multicast session configuration of the UE based on the received group notification message.

According to another embodiment of the present disclosure, a network for managing one or more multicast broadcast service (MBS) multicast sessions in a user equipment (UE) is disclosed. The network is configured to transmit a group notification message to the plurality of UEs for the one or more MBS multicast sessions. The group notification message includes at least one of an identity corresponding to at least one of the one or more MBS multicast sessions, a session status, an indication of Radio Resource Control (RRC) state, a congestion status, and a change of MBS multicast session configuration.

### Advantageous Effects of Invention

Aspects of the present disclosure provide efficient communication methods in a wireless communication system.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIG. 1 illustrates a block diagram of a User Equipment (UE) for managing one or more multicast broadcast service (MBS) multicast sessions in the UE, according to an embodiment of the present disclosure;

FIG. 2A illustrates a flow diagram for performing a group notification or group paging when UEs receive at least one of session activation and session deactivation notifications, according to an embodiment of the present disclosure;

FIG. 2B illustrates a flow diagram for performing a group notification or group paging when UEs receive at least one of session activation and session deactivation notifications, according to an embodiment of the present disclosure;

FIG. 3A illustrates a flow diagram for performing a group notification or group paging when UEs receive at least one of session activation and session release notifications, according to an embodiment of the present disclosure;

FIG. 3B illustrates a flow diagram for performing a group notification or group paging when UEs receive at least one of session activation and session release notifications, according to an embodiment of the present disclosure;

FIG. 4A illustrates a flow diagram for performing a group notification or group paging when the UE transitions to a Radio Resource Control (RRC)_CONNECTED state, according to an embodiment of the present disclosure;

FIG. 4B illustrates a flow diagram for performing a group notification or group paging when the UE transitions to a Radio Resource Control (RRC)_CONNECTED state, according to an embodiment of the present disclosure;

FIG. 5 illustrates a flow chart depicting an operation of the UE for managing the one or more MBS multicast sessions in RRC_INACTIVE, according to an embodiment of the present disclosure;

FIG. 6 illustrates an operational flow diagram depicting an operation of the UE for managing the one or more MBS multicast sessions, according to an embodiment of the present disclosure;

FIG. 7 is a flow diagram illustrating a method for managing the one or more MBS multicast sessions in the UE, in accordance with an embodiment of the present disclosure;

FIG. 8 is a flow diagram illustrating a method for managing the one or more MBS multicast sessions in a plurality of UEs, in accordance with an embodiment of the present disclosure;

FIG. 9 illustrates a block diagram of a terminal (or a user equipment (UE), according to embodiments of the present disclosure; and

FIG. 10 illustrates a block diagram of a base station, according to embodiments of the present disclosure.

### MODE FOR THE INVENTION

New Radio (NR) Multicast Broadcast Services (MBS) refer to multicast services and broadcast services. These multicast services are used to share common content with a group of User Equipment (UEs) which are a part of a multicast group in a multicast coverage area. Further, the multicast coverage area corresponds to a geographical zone in which the group of UEs receive the common content. Further, the broadcast services are used to share the common contents with all the UEs in a broadcast coverage area. The multicast coverage and/or broadcast coverage area can be one or more radio cells.

In a legacy system i.e., Third Generation Partnership Project (3GPP)

Release 17 MBS, a group notification or a group paging mechanism is utilized for the purpose of informing UEs about multicast session “activation” in a Radio Resource Control (RRC)_IDLE state or an RRC_INACTIVE state. Based on the reception of this paging, the UE transits to an RRC_CONNECTED state and starts receiving the multicast session(s). However, there may also be UEs that are configured to receive multicast session(s) in the RRC_INACTIVE state e.g., but cannot receive the multicast session(s) in the RRC_INACTIVE state as there is no such provision in the legacy system. Thus, it is required to extend multicast service delivery to such UEs in RRC_INACTIVE for enhancing the capacity of the network to serve more number of UEs. Hence, the behaviour for such UEs is required to be specified for the handling of multicast session group notification or group paging.

Further, a potential issue relates to the UEs that has joined the multicast session(s) and the multicast session(s) is not activated (i.e., UEs for which the multicast session(s) is deactivated or is not yet activated) and the UEs may be transitioned to the RRC_INACTIVE state, the RRC_IDLE state, or a combination thereof. Another potential issue relates to the UEs for which multicast session(s) is active in the RRC_INACTIVE state or remains active upon transitioning to the RRC_INACTIVE state or a combination thereof but the UEs cannot receive the multicast session(s) in the RRC_INACTIVE state. Further, it is possible that the relevant multicast session(s) may be released at some point of time by the network. However, as the UEs are in the RRC_INACTIVE state, RRC_IDLE state, or a combination thereof, the UEs are not aware of the session(s) release and therefore, may either continue to indefinitely monitor for the group paging message (e.g., for activation) or may not monitor for the group paging message. In any case, these UEs suffer as they are unaware of the multicast session(s) release. In particular, the UEs suffer because of increase in power consumption and processing time.

Moreover, the upper layers of NR (e.g., Non-Access Stratum, NAS) are also not informed about the session release as there is no NAS signalling received in the RRC_INACTIVE state. On the other hand, if the network does send NAS layer signalling, it requires transition of the individual UE to the RRC_CONNECTED state just for release purposes, and this causes massive signalling burden and/or network congestion.

Another issue relates to the UEs for which multicast session(s) is active (on-going) in the RRC_INACTIVE state. However, it is possible that the relevant multicast session(s) is deactivated by the network. Since the UEs are in the RRC_INACTIVE state, the UEs are unaware about the session “deactivation” and do not monitor for the group notification or group paging message. In such case, these UEs suffer as they do not get to know about the multicast session(s) deactivation.

Another issue relates to a scenario when the UE is in the RRC_INACTIVE state and receives Radio Access Network (RAN) paging and multicast session(s) group notification (i.e., group paging) in the same paging message. The behaviour of the UE is not clear in this scenario. Yet another issue relates to a scenario when the UE, in the RRC_INACTIVE state, receives Core Network (CN) paging and multicast session group notification (i.e., group paging) in the same paging message. The behaviour of the UE is not clear in this scenario. Thus, the UE faces a dilemma as to how to handle one of the two paging or handle both paging.

Thus, it is desired to address the above-mentioned disadvantages or shortcomings or at least provide a useful alternative for MBS multicast sessions in the UE.

For the purpose of promoting an understanding of the principles of the disclosure, reference will now be made to the various embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

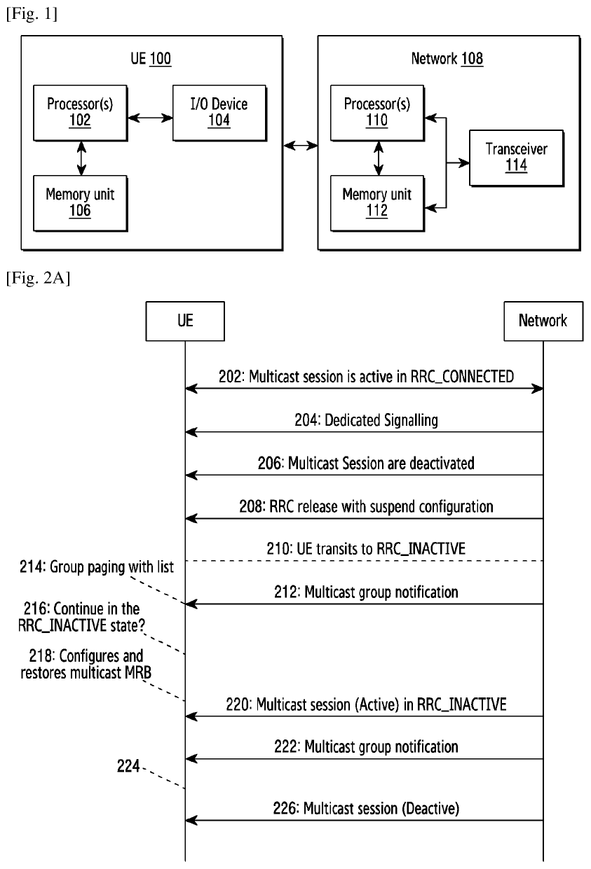

FIG. 1 illustrates a block diagram of a User Equipment (UE) 100 for managing one or more multicast broadcast service (MBS) multicast sessions in the UE 100, according to an embodiment of the present disclosure. The configuration of FIG. 1 may be understood as a part of the configuration of UE 100.

In an embodiment of the present disclosure, the one or more MBS multicast sessions refer to data sessions associated with multicast services and broadcast services. The UE 100 uses the data sessions to receive content associated with the multicast services upon joining a multicast group in a multicast coverage area. Further, the UE 100 may also use the data sessions to receive content associated with the broadcast services in a broadcast coverage area.

Referring to FIG. 1, the UE 100 may include one or more processors 102, an Input/Output (I/O) interface 104 (e.g., communicator or communication interface, or a transceiver), and a memory unit 106 (e.g., storage). In an exemplary embodiment of the present disclosure, the UE 100 may correspond to a smartphone, a laptop computer, a desktop computer, a wearable device, and the like. The I/O interface 104 may perform functions for transmitting and receiving signals via a wireless channel.

As an example, the one or more processors 102 may be a single processing unit or a number of units, all of which could include multiple computing units. The one or more processors 102 may be implemented as one or more microprocessors, microcomputers, microcontrollers, digital signal processors, central processing units, state machines, logic circuitries, and/or any devices that manipulate signals based on operational instructions. Among other capabilities, the one or more processors 102 are configured to fetch and execute computer-readable instructions and data stored in the memory. The one or more processors 102 may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an Artificial Intelligence (AI)-dedicated processor such as a neural processing unit (NPU). The one or more processors 102 may control the processing of the input data in accordance with a predefined operating rule or AI model stored in the non-volatile memory and the volatile memory, i.e., memory unit 106. The predefined operating rule or artificial intelligence model is provided through training or learning.

The memory unit 106 may include any non-transitory computer-readable medium known in the art including, for example, volatile memory, such as static Random-Access memory (SRAM) and dynamic random access memory (DRAM), and/or non-volatile memory, such as read-only memory (ROM), erasable programmable ROM, flash memories, hard disks, optical disks, and magnetic tapes.

Some example embodiments disclosed herein may be implemented using processing circuitry. For example, some example embodiments disclosed herein may be implemented using at least one software program running on at least one hardware device and performing network management functions to control the elements.

In an embodiment of the present disclosure, the one or more processors 102 include a Communication Processor (CP) and an Application Processor (AP). For example, the CP is like a modem. The CP is configured to handle Layer 2 and other protocols. In an embodiment of the present disclosure, the AP is associated with upper layers, such as network layer, transport layer, and application layer.

Further, the one or more processors 102 may be disposed in communication with one or more I/O devices via the I/O interface 104. The I/O interface 104 may employ communication code-division multiple access (CDMA), high-speed packet access (HSPA+), global system for mobile communications (GSM), long-term evolution (LTE), WiMax, 5G New Radio (NR) or the like, etc.

Using the I/O interface 104, the UE 100 may communicate with one or more I/O devices, specifically, the user devices associated with the human-to-human conversation. For example, the input device may be an antenna, microphone, touch screen, touchpad, storage device, transceiver, video device/source, etc. The output devices may be a printer, fax machine, video display (e.g., cathode ray tube (CRT), liquid crystal display (LCD), light-emitting diode (LED), plasma, Plasma Display Panel (PDP), Organic light-emitting diode display (OLED) or the like), audio speaker, etc.

The one or more processors 102 may be disposed in communication with a communication network via a network interface. In an embodiment, the network interface may be the I/O interface 104. The network interface may connect to the communication network to enable connection of the UE 100 with the outside environment. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, a wireless network and the like.

In an embodiment of the present disclosure, the UE 100 is communicatively coupled to a network 108 for receiving a group notification message from the network 108, as shown in FIG. 1. In an embodiment, the network 108 may be one of a plurality of cellular networks (such as a 3G, 4G, a 5G or pre-5G, 6G network or any future wireless communication network). Further, the network may include one or more processors 110, a memory unit 112, and a transceiver 114 communicatively coupled with the one or more processors 110 and the memory unit 112. In an embodiment of the present disclosure, the transceiver 114 is an electronic device or circuit that transmits and receives analog or digital signals, either wired or wireless.

In an embodiment of the present disclosure, the one or more processors 102 of the UE 100 may be configured to determine if the UE joined one or more MBS multicast sessions in a Radio Resource Control (RRC)_INACTIVE state. Further, the one or more processors 102 determines if the UE 100 is configured to receive, currently receiving, or a combination thereof the one or more MBS multicast sessions in the RRC_INACTIVE state upon determining that the UE has joined the one or more MBS multicast sessions.

In an embodiment, the one or more processors 102 of the UE 100 may be configured to receive a group notification message for the one or more MBS multicast sessions in the RRC_INACTIVE state upon determining that the UE 100 is configured to receive, currently receiving, or a combination thereof the one or more MBS multicast sessions in the RRC_INACTIVE state. The one or more MBS multicast sessions may include an activated session, a deactivated session, or a combination thereof. In an exemplary embodiment of the present disclosure, the group notification message may include an identity corresponding to at least one of the one or more MBS multicast sessions, a session status, an indication of RRC state, a congestion status, a change of MBS multicast session configuration, and the like. It should be noted that group notification message may include other information related to the MBS multicast session or the UE and any such information will fall within the scope of the present disclosure. In an exemplary embodiment of the present disclosure, the session status may include a session activation status, a session deactivation status, a session release status, and a session configuration modification status. Further, the RRC state includes an RRC_CONNECTED state, and an RRC_INACTIVE state. In an embodiment of the present disclosure, the change of MBS multicast session configuration includes at least one of the indications of the change of MBS multicast session configuration and an updated MBS multicast session configuration. In an embodiment of the present disclosure, the multicast session configuration may include radio bearer configuration parameters, Medium Access Control (MAC) configuration parameters and physical layer configuration parameters that are required to set up a multicast channel and establish multicast bearers to receive the MBS multicast traffic in the RRC_INACTIVE state.

In an embodiment of the present disclosure, session, multicast session, and the multicast MBS session are used interchangeably throughout the disclosure.

Further, when the UE 100 is in the RRC_INACTIVE state, the one or more processors 102 may be configured to store a session modification configuration of the one or more MBS multicast sessions received in the group notification message. The one or more processors 102 may also be configured to update the configuration of the one or more MBS multicast sessions based on the stored session modification configuration.

In a further embodiment, the one or more processors 102 may be configured to receive the group notification message via a group paging message, a Multicast MBS Control Channel (MCCH) message or a combination thereof, when the UE 100 is in an RRC_INACTIVE state and is configured to receive and is receiving an MBS multicast session in the RRC_INACTIVE state. Further, the one or more processors 102 may be configured to receive the group paging message in each of a first list and a second list while receiving the group notification message via the group paging message.

In an embodiment of the present disclosure, the first list is received for first group of the one or more MBS multicast sessions that are not configured to be received in the RRC_INACTIVE state and the second list is received for a second group of the one or more MBS multicast sessions that are configured to be received in RRC_INACTIVE state. The first list may include the group paging for the first group of the one or more MBS multicast sessions i.e., legacy MBS multicast sessions. In an embodiment of the present disclosure, the legacy MBS multicast sessions correspond to Third Generation Partnership Project (3GPP) Release 17 MBS and/or MBS multicast sessions that are not configured to be received in the RRC_INACTIVE state. Further, the second list may include the group paging for the second group of the one or more MBS multicast sessions i.e., 3GPP Release 18 MBS and/or MBS multicast sessions that are configured to be received in the RRC_INACTIVE state. This is due to difference in behaviour of the UE 100 related to the one or more MBS sessions when the group paging is received by the UE 100, based on the configuration of the UE to receive or not receive the one or more multicast sessions in the RRC_INACTIVE.

In an embodiment of the present disclosure, the concept of the first list and the second list allows the one or more processors 102 to handle the group paging for the UEs which are capable and/or configured to receive multicast in RRC_INACTIVE state and for the UEs which are not capable and/or not configured to receive multicast in RRC_INACTIVE state. Particularly, UEs which are supporting 3GPP Release 18 MBS may be capable and/or configured to receive multicast in RRC_INACTIVE state, whereas UEs pertaining to previous release (i.e., 3GPP Release 17 MBS) may not be capable and/or not configured to receive multicast in RRC_INACTIVE state. Thus, the one or more processors 102 allows the co-existence of these two sets of UEs in the same cell/network 108.

In an alternate embodiment, the first list and the second list may be a common list including a session id for each of the group paging message to identify of a type of the one or more MBS multicast sessions. The type of the one or more MBS multicast sessions may correspond to a type of group paging i.e., the group paging for the legacy MBS multicast sessions (i.e., MBS multicast sessions that are not configured to be received in RRC_INACTIVE state) and the group paging associated with the 3GPP Release 18 MBS and/or MBS multicast sessions that are configured to be received in RRC_INACTIVE state. In an embodiment of the present disclosure, multicast session group notification (or group paging) is provided through the common list or a paging-GroupList in the group paging message carrying a list of Temporary Mobile Group Identity (TMGI) for which the session status is changed (e.g., activation). In an embodiment of the present disclosure, the multicast session group notification AND the group paging are used interchangeably throughout the disclosure.

In an embodiment of the present disclosure, the common list (i.e., the paging-GroupList) may be provided in the group paging message carrying the list of TMGIs for notification to the UEs that may be capable and/or configured to receive multicast in RRC_INACTIVE state and to the UEs that may not be capable and/or configured to receive multicast in RRC_INACTIVE state. Further, one or more additional fields in the common list can be added for indicating cause like activation, deactivation, modification or release indication, congestion status, RRC state, or any combination thereof. In an embodiment of the present disclosure, the one or more additional fields can be represented by a flag, a bit, a bitmap, or a code-point and can also be provided separately or combined.

In another embodiment, the second list (i.e., a pagingGroupList-r18/paging-GroupList-MbsInactive and a pagingGroupList) are provided in the group paging message, respectively, carrying the list of TMGIs for notification to the UEs that may be capable and/or configured to receive multicast in RRC_INACTIVE state (e.g., 3GPP Rel18 MBS UEs) and the first list carrying a list of TMGIs for notification to the UEs that may not be capable and/or configured to receive multicast in RRC_INACTIVE state (e.g., 3GPP Rel17 MBS UEs) (Refer to table 1 shown). Also, without the loss of generality, there may be multicast sessions for Rel18 MBS UEs, that may not be configured to be received in RRC_INACTIVE. The group notification for these sessions may be included in the first list. In an embodiment of the present disclosure, if the network 108 includes pagingGroupList-r18, it includes the same number of entries, and is listed in the same order, as in pagingGroupList (i.e., without suffix). For example, TMGI field is present in the first list (pagingGroupList) and field(s) indicating the cause, such as activation, deactivation, modification or release indication, congestion status, RRC state, or any combination thereof are present in the second list (pagingGroupList-r18). In another embodiment, both the first list and the second list can carry at least TMGI fields.

An example of paging message structure specification is shown below (Example 1) where in separate list of TMGIs is included in the paging message for:

TABLE 1
Paging message

| | |
|---|---|
| Paging ::= | SEQUENCE { |
| pagingRecordList | PagingRecordList |

OPTIONAL, -- Need N

| | |
|---|---|
| lateNonCriticalExtension | OCTET STRING |

OPTIONAL,

| | |
|---|---|
| nonCriticalExtension | Paging-v1700-IEs |

```
      OPTIONAL
    }
```

| | |
|---|---|
| Paging-v1700-IEs ::= | SEQUENCE { |
| pagingRecordList-v1700 | PagingRecordList-v1700 |

OPTIONAL, -- Need N

| | |
|---|---|
| pagingGroupList-r17 | PagingGroupList-r17 |

OPTIONAL,

| | |
|---|---|
| nonCriticalExtension | Paging-vXYZ-IEs |

```
      OPTIONAL
    }
```

| | |
|---|---|
| Paging-vXYZ-IEs ::= | SEQUENCE { |
| pagingGroupList-r18 | PagingGroupList-r18 |

OPTIONAL,

| | |
|---|---|
| nonCriticalExtension | SEQUENCE { } |

```
      OPTIONAL
    }
```

| | |
|---|---|
| PagingRecordList ::= | SEQUENCE (SIZE(1..maxNrofPageRec)) OF |

PagingRecord

| | |
|---|---|
| PagingRecordList-v1700 ::= | SEQUENCE (SIZE(1..maxNrofPageRec)) OF |

PagingRecord-v1700

| | |
|---|---|
| PagingGroupList-r17 ::= | SEQUENCE (SIZE(1..maxNrofPageGroup-r17)) OF |

TMGI-r17

| | |
|---|---|
| PagingGroupList-r18 ::= | SEQUENCE (SIZE(1..maxNrofPageGroup-r18)) OF |

TMGI-r18

| | |
|---|---|
| PagingRecord ::= | SEQUENCE { |
| ue-Identity | PagingUE-Identity, |
| accessType | ENUMERATED {non3GPP} OPTIONAL, -- Need |

```
      N
      ...
    }
```

| | |
|---|---|
| PagingRecord-v1700 ::= | SEQUENCE { |
| pagingCause-r17 | ENUMERATED {voice} OPTIONAL -- Need |

```
      N
  }
```

| | |
|---|---|
| PagingUE-Identity ::= | CHOICE { |
| ng-5G-S-TMSI | NG-5G-S-TMSI, |
| fullI-RNTI | I-RNTI-Value, |

...
}

In an embodiment, the common list (i.e., a pagingGroupList), the first list and the second list, or any combination thereof (i.e. a pagingGroupList-r18/pagingGroupList-Mb-sInactive and a pagingGroupList) may carry MBS session identity (e.g., Temporary Mobile Group Identifier, TMGI), group paging cause or status notification (e.g., activation, deactivation, release, configuration modification), the indication for RRC state (e.g., continue in RRC_INACTIVE state, transition to RRC_CONNECTED), the congestion status, or any combination thereof. The group paging cause, the indication for RRC state, the congestion status, or any combination thereof may be explicitly, implicitly included, or provided by the group paging message. Further, at least one of these fields may be provided per TMGI or commonly for overall multicast TMGIs in the paging message (Refer to Example 5 shown). In an alternative embodiment of the present disclosure, one of these fields can be represented by a flag, a bit, a bitmap, or a code-point and can also be provided separately or combined together.

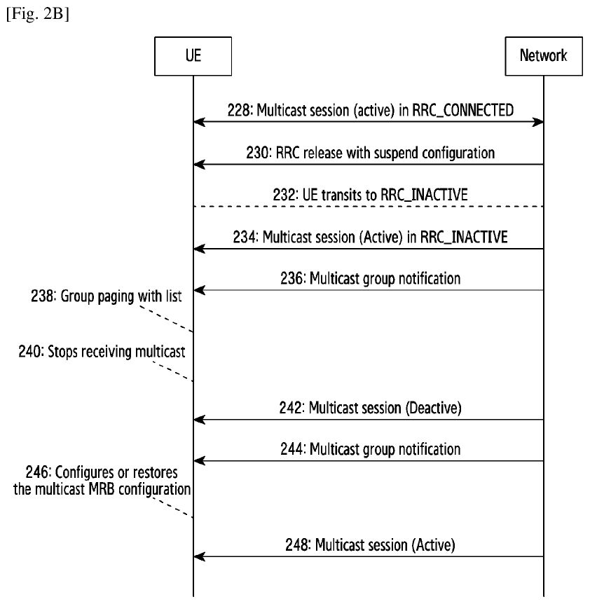

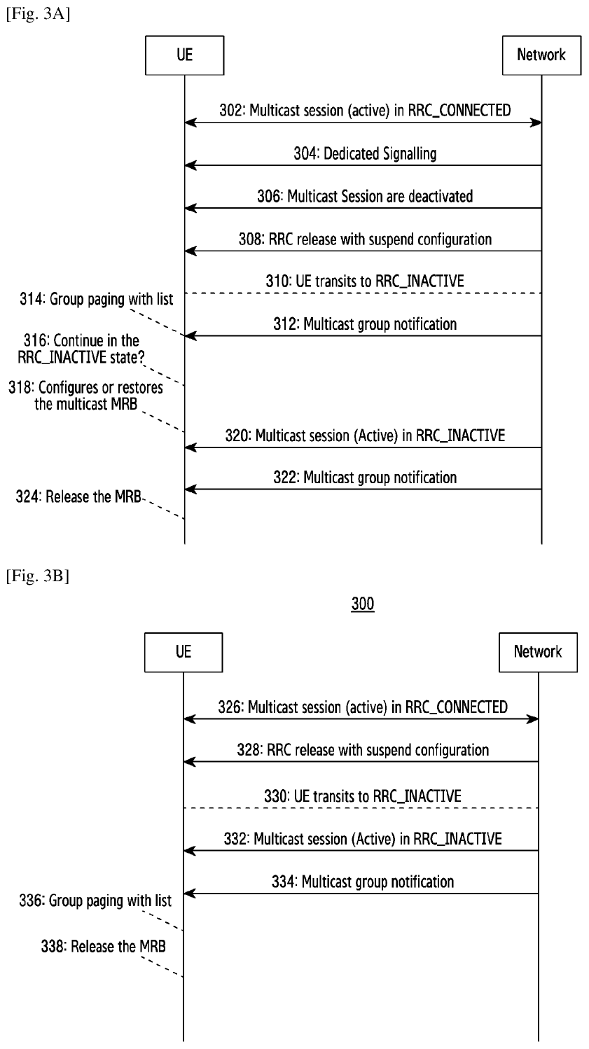

In an embodiment of the present disclosure, a group paging cause is signaled as part of the group paging message carrying a group paging record. The group paging record indicates the reason for group paging. In an exemplary embodiment of the present disclosure, the group paging cause can be activation, deactivation, modification, or release of the one or more MBS multicast sessions. Furthermore, the group paging cause may be signaled implicitly or explicitly in the group paging message. As depicted in sample ASN signaling structure in table 2, the group paging message carries group paging IDs (e.g., TMGIs) as part of an existing pagingGroupList IE, the group paging cause values sent in a second or parallel list (i.e., PagingGroupList-r18), the group paging IDs (e.g., also termed as MBS session IDs or TMGIs) in the existing list associated with the cause in the second list. In an embodiment of the present disclosure, the second list carrying paging causes may be associated with the first list which carries the TMGIs. In an embodiment of the present disclosure, the group paging cause values indicate MBS multicast session activation, deactivation, modification, or release. For example, legacy UE may receive only the first list and act as in legacy (i.e., goes to RRC_CONNECTED for the TMGI indicated in the first list). While for the Rel18 UE, the MBS multicast session is configured to be received in RRC_INACTIVE for receiving both the first list (e.g., for TMGI field) and the second list (e.g., for cause) and continues to be the RRC_INACTIVE to receive multicast session. Alternatively, as presented in Example 3, the group paging IDs (TMGIs) notifying session deactivation, modification and release are signaled separately along with the associated group paging cause. Further, the legacy pagingGroupList indicates the group paging IDs (TMGIs) which are present to notify session activation alone. The details on performing the group paging when UEs receive the group notification message indicating session activation, session deactivation notifications, and session release have been elaborated in subsequent paragraphs at least with reference to FIG. 2A, FIG. 2B, FIG. 3A, and FIG. 3B.

TABLE 2

| | |
|---|---|
| Paging-v1700-IEs ::= | SEQUENCE { |
| pagingRecordList-v1700 | PagingRecordList-v1700 |

OPTIONAL, -- Need N

| | |
|---|---|
| pagingGroupList-r17 | PagingGroupList-r17 |

OPTIONAL,

| | |
|---|---|
| nonCriticalExtension | Paging-vXYZ-IEs |

```
    OPTIONAL
  }
```

| | |
|---|---|
| PagingGroupList-r17 ::= | SEQUENCE (SIZE(1..maxNrofPageGroup- |

r17)) OF TMGI-r17

| | |
|---|---|
| Paging-vXYZ -IEs ::= | SEQUENCE { |
| pagingGroupList-r18 | PagingGroupList-r18 |
| OPTIONAL, nonCriticalExtension | SEQUENCE{ } |
| | OPTIONAL |

```
  }
  PagingGroupList-r18 ::= SEQUENCE (SIZE(1..maxNrofPageGroup-r17)) OF
    PagingGroupRecord-v1800
```

| | |
|---|---|
| PagingGroupRecord-v1800 ::= | SEQUENCE { |
| groupPagingCause-r18 | ENUMERATED {modification, deactivation, |

release} OPTIONAL
}

In an embodiment of the present disclosure, the groupPagingCause-r18 Indicates cause for group paging message initiation as MBS session modification, deactivation or release. If the groupPagingCause-r18 field is not present but corresponding paging-GroupList-r17 record is present, it implies that the corresponding group paging entry is for a service activation. Another example of paging message structure specification is shown below (table 3), where in groupPagingId and groupPagingCause are carried in the paging record for PagingGroupList-r18:

TABLE 3

| | |
|---|---|
| Paging-vXYZ -IEs ::= | SEQUENCE { |
| pagingGroupList-r18 | PagingGroupList-r18 |
| OPTIONAL, nonCriticalExtension | SEQUENCE{ } |
| | OPTIONAL |

}
PagingGroupList-r18 ::= SEQUENCE (SIZE(1..maxNrofPageGroup-r17)) OF
PagingGroupRccord-r18

| | |
|---|---|
| PagingGroupRecord-r18 ::= | SEQUENCE { |
| groupPagingId-r18 | TMGI-r17, |
| groupPagingCause-r18 | ENUMERATED {modification, |
| deactivation,release} | OPTIONAL |

}

In an embodiment of the present disclosure, PagingGroupList-r18 includes a list of pagingGroupRecords which indicates the MBS session identities being paged along with the cause for paging which can be modification, deactivation or release. Further, groupPagingCause-r18 indicates the group paging cause, which can be session deactivation, session modification, or session release. In PagingGroupRecord, if groupPagingCause is absent for a groupPagingId, it indicates that the session is being activated. Another example of paging message structure specification is shown below (table 4), wherein PagingGroupList-r18 consists of separate lists of TMGIs for session deactivation, session modification and session release:

TABLE 4

| | |
|---|---|
| Paging-vXYZ -IEs ::= | SEQUENCE { |
| pagingGroupList-r18 | PagingGroupList-r18 |
| OPTIONAL, nonCriticalExtension | SEQUENCE{ } |

OPTIONAL
}

| | |
|---|---|
| PagingGroupList-r18 ::= | SEQUENCE { |
| sessionToDeactivateList-r18 | SEQUENCE |

```
  (SIZE(1..maxNrofPageGroup-r17)) OF TMGI-r17
      OPTIONAL,
```

| | |
|---|---|
| sessionToModifyList-r18 | SEQUENCE |

```
  (SIZE(1..maxNrofPageGroup-r17)) OF TMGI-r17
      OPTIONAL,
```

| | |
|---|---|
| sessionToReleaseList-r18 | SEQUENCE |

```
  (SIZE(1..maxNrofPageGroup-r17)) OF TMGI-r17
      OPTIONAL
}
```

In an embodiment of the present disclosure, the sessionToDeactivateList includes a list of sessions to be deactivated. If the UE 100 is subscribed to the session indicated in the sessionToDeactivateList, the UE 100 considers the indicated session as being deactivated. Further, the sessionToModifyList includes a list of sessions to be modified. If the UE 100 is subscribed to the session indicated in this list, the UE 100 considers the indicated session as being modified and UE 100 initiates procedure to obtain the updated session parameters. Furthermore, the sessionToReleaseList includes a list of sessions to be released. If UE 100 is subscribed to the indicated session indicated in this list, the UE 100 considers it as being released and the UE 100 stops monitoring further paging for this session.

Another example of paging message structure specification is shown below (table 5). The paging message structure specification carries MBS session identity (e.g., TMGI), group paging cause or status notification (e.g., activation, deactivation, release, configuration modification), an indication for RRC state (e.g., continue in RRC_INACTIVE state, transition to RRC_CONNECTED), the congestion status, or any combination thereof.

TABLE 5
Paging message

| | |
|---|---|
| Paging ::= | SEQUENCE { |
| pagingRecordList | PagingRecordList |

OPTIONAL, -- Need N

| | |
|---|---|
| lateNonCriticalExtension | OCTET STRING |

OPTIONAL,

| | |
|---|---|
| nonCriticalExtension | Paging-v1700-IEs |

```
    OPTIONAL
  }
```

| | |
|---|---|
| Paging-v1700-IEs ::= | SEQUENCE { |
| pagingRecordList-v1700 | PagingRecordList-v1700 |

OPTIONAL, -- Need N

| | |
|---|---|
| pagingGroupList-r17 | PagingGroupList-r17 |

OPTIONAL,

| | |
|---|---|
| nonCriticalExtension | Paging-vXYZ-IEs |

```
    OPTIONAL
  }
```

| | |
|---|---|
| Paging-vXYZ-IEs ::= | SEQUENCE { |
| pagingGroupList-r18 | PagingGroupList-r18 |

OPTIONAL,

| | |
|---|---|
| nonCriticalExtension | SEQUENCE { } |

```
    OPTIONAL
  }
```

| | |
|---|---|
| PagingRecordList ::= | SEQUENCE (SIZE(1..maxNrofPageRec)) OF |

PagingRecord

| | |
|---|---|
| PagingRecordList-v1700 ::= | SEQUENCE (SIZE(1..maxNrofPageRec)) OF |

PagingRecord-v1700

| | |
|---|---|
| PagingGroupList-r17 ::= | SEQUENCE (SIZE(1..maxNrofPageGroup-r17)) OF |

TMGI-r17

| | |
|---|---|
| PagingGroupList-r18 ::= | SEQUENCE (SIZE(1..maxNrofPageGroup-r18)) OF |

PagingRecord-v1800

| | |
|---|---|
| PagingRecord ::= | SEQUENCE { |
| ue-Identity | PagingUE-Identity, |
| accessType | ENUMERATED {non3GPP} OPTIONAL, -- Need |

```
    N
    ...
  }
```

| | |
|---|---|
| PagingRecord-v1700 ::= | SEQUENCE { |
| pagingCause-r17 | ENUMERATED {voice} OPTIONAL -- Need |

```
    N
  }
```

| | |
|---|---|
| PagingRecord-v1800 ::= | SEQUENCE { |
| groupPagingId-r18 | TMGI-r17, |
| groupPagingCause-r18 | ENUMERATED {activation, deactivaion, release, |

modification} OPTIONAL

| | |
|---|---|
| rrcState-r18 | ENUMERATED {inactive, connected} OPTIONAL |
| congestionStatus-r18 | ENUMERATED {congestion} OPTIONAL |

}

| | |
|---|---|
| PagingUE-Identity ::= | CHOICE { |
| ng-5G-S-TMSI | NG-5G-S-TMSI, |
| fullI-RNTI | I-RNTI-Value, |

...
}

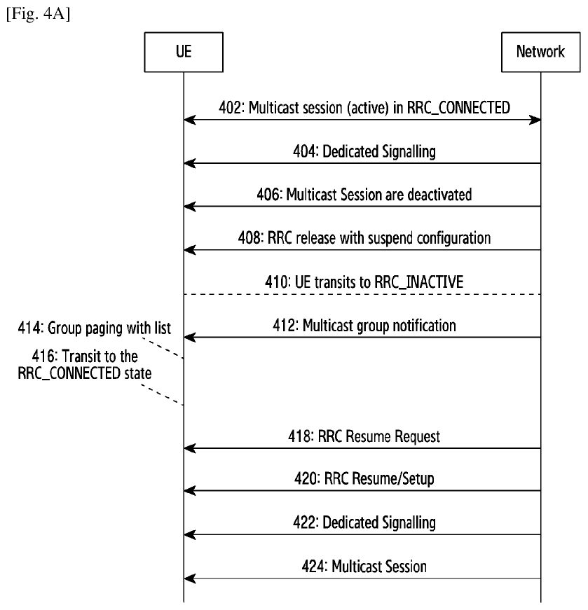

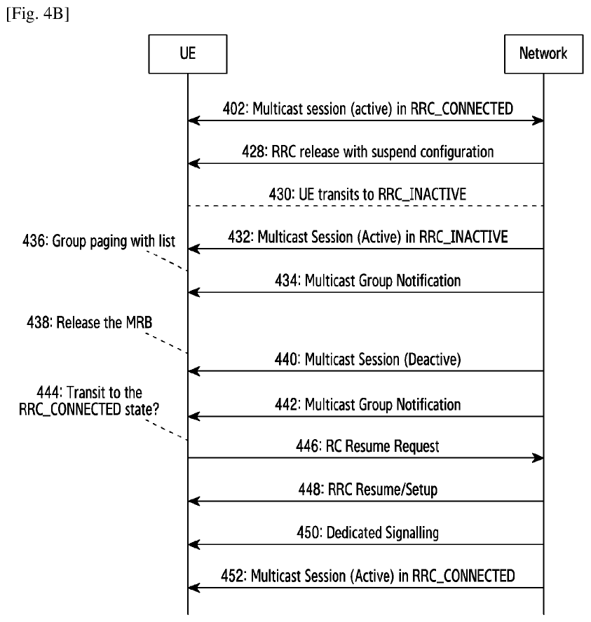

Further, the groupPagingCause-r18 indicates the group paging cause for the session indicated by groupPagingId-r18, which can be session activation, deactivation, session modification or session release. Furthermore, rrcState-r18 indicates the state for which the UE 100 is required to transition to connected or remain in INACTIVE state to receive multicast session. The congestionStatus-r18 indicates the congestion status at network and may also implicitly indicate if the UE 100 can transition to RRC_CONNECTED state or remain in INACTIVE state. The details on performing the group paging when the UE 100 transitions to the RRC_CONNECTED state have been elaborated in subsequent paragraphs at least with reference to FIG. 4A and FIG. 4B.

In an embodiment, activation for MBS multicast session is implied, or implicitly or explicitly indicated by the group notification. The UE 100 which is capable or configured to receive multicast in RRC_INACTIVE state and is in the RRC_INACTIVE state, monitors the group paging or notification for the TMGI for which group paging or notification conveying ‘activation’ is received. Further, the UE 100 may indicate the associated TMGI to the upper layers (e.g., NAS and/or service layers). If the UE 100 is already receiving the multicast session for this TMGI actively in the RRC_INACTIVE state, the UE 100 may not monitor the group paging for the TMGI.

In an embodiment of the present disclosure, the one or more processors 102 may be configured to change the session status of the one or more MBS multicast sessions, the RRC state and the MBS multicast session configuration of the UE 100 based on the received group notification message.

In an embodiment, activation, deactivation, release, a RRC state, a congestion, a configuration change, or any combination thereof for a MBS multicast session may be implied, or implicitly or explicitly indicated by the group notification conveyed by the MCCH message. For an example, a deactivation of the multicast session can be explicitly indicated by Multicast MCCH and/or implicitly indicated by the removal of the multicast session configuration in the multicast MCCH.

Further, the one or more processors 102 may be configured to inform a non-access stratum (NAS) layer of one or more multicast MBS sessions release via a NAS signalling, when the UE 100 is in an RRC_CONNECTED state. The one or more MBS multicast sessions release is determined based on a removal of the MBS multicast session configuration in the group notification message (e.g., the multicast MCCH message) when the UE 100 is in the RRC_INACTIVE state. Further, the one or more MBS multicast sessions release is indicated in the group notification message (e.g., group paging or multicast MCCH) when the UE 100 is in the RRC_INACTIVE state.

Further, the one or more processors 102 may be configured to switch the RRC state of the UE 100 from an RRC_CONNECTED state to an RRC_INACTIVE state based on a configuration for at least one multicast session reception in the RRC_INACTIVE state. In an embodiment of the present disclosure, the configuration is received via an RRCRelease with suspendConfig message. The one or more processors 102 may be configured to continue receiving the multicast session reception upon switching to the RRC_INACTIVE state, wherein the MBS multicast session is in an activated state. The one or more processors 102 may be configured to continue monitoring the group notification message for the MBS multicast session upon switching to the RRC_INACTIVE state. In an exemplary embodiment of the present disclosure, the group paging or group notification monitoring can be continued by the UE 100 in both activated state (e.g., for deactivation notification, configuration update, and the like) and deactivated state (e.g., for activation notification).

Furthermore, the one or more processors 102 may be configured to switch the RRC state of the UE 100 from an RRC_INACTIVE state to an RRC_CONNECTED state based on the group notification message upon achieving one or more conditions. In an exemplary embodiment of the present disclosure, the one or more conditions may include absence of a RRC state field in the group notification message, an RRC state field including RRC_CONNECTED state, the group notification message indicating the one or more MBS multicast session not configured to be received in an RRC_INACTIVE state, or any combination thereof. The one or more processors 102 may be configured to receive the one or more multicast session reception of data upon switching to the RRC_CONNECTED state.

The one or more processors 102 may be configured to determine an occurrence of one or more first events based on the received group notification message. In an embodiment of the present disclosure, the one or more first events include session activation, resumption of data transmission, or a combination thereof. Further, the one or more processors 102 may be configured to monitor a Group-Radio Network Temporary Identifier (G-RNTI) or Group-Configured Scheduled Radio Network Temporary Identifier (G-CS-RNTI) upon determining the occurrence of the one or more first events. In an embodiment of the present disclosure, the UE 100 remains in an RRC_INACTIVE state upon occurrence of the one or more first events.

Furthermore, the one or more processors 102 may be configured to determine an occurrence of one or more second events based on the received group notification message. In an embodiment of the present disclosure, the one or more second events include session deactivation, temporary no data availability, or a combination thereof. The one or more processors 102 may be configured to discontinue monitoring of the G-RNTI or the G-CS-RNTI upon determining the occurrence of the one or more second events. In an embodiment of the present disclosure, the UE 100 remains in an RRC_INACTIVE state upon occurrence of the one or more second events.

Further, the one or more processors 102 may be configured to determine if both unicast paging and group paging/group notification is received by the UE 100 in the RRC_INACTIVE state in the same paging message, wherein the unicast paging corresponds to a Radio Access Network (RAN) paging. In an embodiment of the present disclosure, the group paging corresponds to a multicast session configured to be received in RRC_INACTIVE state. In such case, the one or more processors 102 may prioritize the unicast paging and may be configured to execute the unicast paging via the UE 100. The one or more processors 102 may also be configured to initiate the RRC connection resumption procedure. Further, the one or more processors 102 may be configured to switch the RRC state of the UE 100 to an RRC_CONNECTED state upon executing the unicast paging.

Further, the one or more processors 102 may be configured to determine if both unicast paging and the group paging/the group notification is received by the UE 100 in the same paging message, wherein the unicast paging corresponds to a Core Network (CN) paging. In an embodiment of the present disclosure, the group paging corresponds to a multicast session configured to be received in RRC_INACTIVE state. In such case, the one or more processors 102 may prioritize the unicast paging and execute the unicast paging via the UE 100. The one or more processors 102 may also be configured to forward the TMGI for the multicast session indicated in the group paging/the group notification to the upper layers. The one or more processors 102 are configured to transit the UE 100 to the RRC_IDLE state and initiate connection establishment procedure. Further, the one or more processors 102 may be configured to switch the RRC state of the UE 100 to an RRC_CONNECTED state upon executing the unicast paging.

Further, the one or more processors 102 may be configured to receive, by the UE 100, a multicast session in an RRC_INACTIVE state by applying a Point-To-Multipoint (PTM) configuration, when an MBS multicast session is activated. In an embodiment of the present disclosure, the UE 100 stores the PTM configuration before the MBS multicast session is activated. Furthermore, the UE 100 receives the multicast session by applying the PTM configuration. In an embodiment of the present disclosure, the UE 100 receives the PTM configuration for the activated MBS multicast session via an RRCRelease message with suspendconfig, a group notification message, or a combination thereof. For example, the PTM configuration for a (single) serving cell can be configured to UE 100 before the session activation based on a decision of the network 108, and the UE 100 stores the PTM configuration. When session is activated, the UE 100 may receive the multicast in INACTIVE state by applying the PTM configuration without going back to RRC_CONNECTED, if not updated by MCCH after being configured. When the network 108 configures the UE 100 to receive the multicast in the RRC_INACTIVE state, the RRCRelease message with suspendconfig can be used to deliver the PTM configuration. Further, a new MCCH logical channel (i.e., multicast MCCH channel) may be introduced for multicast in the RRC_INACTIVE state (different from broadcast MCCH). In an embodiment of the present disclosure, a multicast MCCH configuration is provided via a System Information Block (SIB). In an embodiment of the present disclosure, multicast MCCH configuration for the serving cell can also be provided in dedicated signalling.

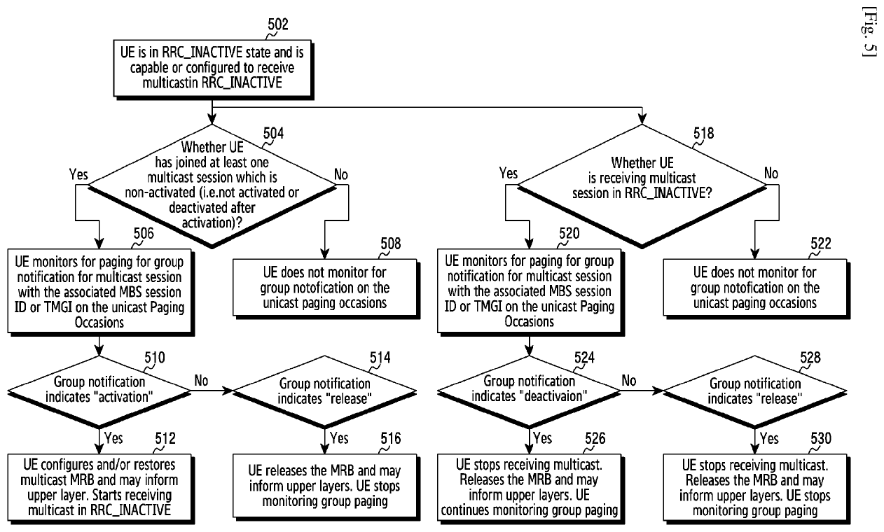

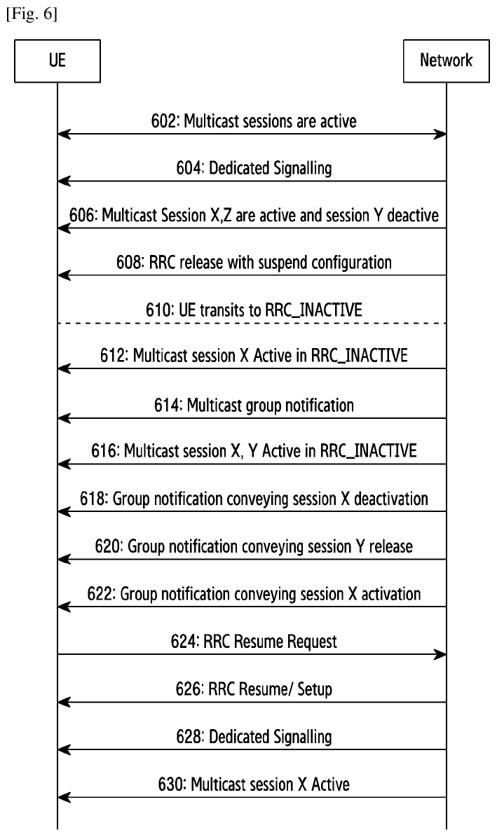

Furthermore, the one or more processors 102 may be configured to continue the one or more MBS multicast sessions in an RRC_INACTIVE state if the RRC state is present in the group notification message and the RRC state is not an RRC_CONNECTED state, or the group notification message is received for the one or more MBS multicast sessions that are configured to be received in the RRC_INACTIVE state. The details on the operation of the UE 100 to manage the one or more MBS multicast sessions have been elaborated in subsequent paragraphs at least with reference to FIG. 5 and FIG. 6.

In an embodiment of the present disclosure, the network 108 may be configured to determine if a plurality of UEs joined the one or more MBS multicast sessions. Further, the network 108 may be configured to determine if the plurality of UEs is configured to receive, currently receiving, or a combination thereof the one or more MBS multicast sessions in the RRC_INACTIVE state upon determining that the plurality of UEs joined the one or more MBS multicast sessions. The network 108 may be configured to determine a change in a session status of the one or more MBS multicast sessions, the congestion status, a change in the RRC state, a change in the multicast session configuration, or any combination thereof for the plurality of UEs upon determining that the plurality of UEs are configured to receive, currently receiving, or a combination thereof the one or more MBS multicast sessions in the RRC_INACTIVE state.

Further, the network 108 may transmit the group notification message to the plurality of UE for the one or more MBS multicast sessions upon determining the change in the session status of the one or more MBS multicast sessions, the congestion status, the change in the RRC state, the change in the multicast session configuration, or any combination thereof. In transmitting the group notification message, the network 108 transmit the group notification message via the group paging message, the MCCH message, or a combination thereof, when the plurality of UEs is in an RRC_INACTIVE state is configured to receive, currently receiving or a combination thereof an MBS multicast session in the RRC_INACTIVE state.

In transmitting the group notification message via the group paging message, the network 108 transmits the group paging message in each of the first list and the second list.

FIG. 2A illustrates a flow diagrams for performing a group notification or a group paging when UE 100 receive at least one of session activation and session deactivation notifications, according to an embodiment of the present disclosure. As explained with respect to FIG. 1, the group paging cause values indicate session activation, deactivation, modification, or release via the group paging message.

FIG. 2A illustrates the process of performing the group paging for UEs configured and capable of receiving multicast session in a Radio Resource Control (RRC)_INACTIVE state. As illustrated in FIG. 2A, multicast session is active in UE in RRC-connected state 202 and the corresponding dedicated signalling is represented as step 204. The network 108 transmits RRC configuration with a Multicast MBS Radio Bearer (MRB) release conveying session deactivation. Further, at step 206, the multicast session is deactivated. Furthermore, at step 208, the network 108 transmits RRC Release with SuspendConfig message. At step 210, the UE 100 transits to the RRC_INACTIVE state.

Further, the UE 100 is capable and/or configured to receive multicast in the RRC_INACTIVE state and group notification for “activation” in the RRC_INACTIVE state, at step 212. The group notification conveys session activation, RRC state, congestion status, or any combination thereof. The UE 100 configures or restores a multicast MRB configuration. In an embodiment of the present disclosure, the multicast MRB configuration correspond to a radio bearer configuration for the MBS multicast session. In an embodiment of the present disclosure, step 214 represents the group paging with the first list, the second list, the common list, or any combination thereof for Ues that are capable or are configured to receive multicast in RRC_INACTIVE state. Further, multicast MRB configuration may also be the one provided to the UE 100 during transition to RRC_INACTIVE state (e.g., through RRC Release with SuspendConfig message). Further, UE 100 starts receiving multicast session in the RRC_INACTIVE state. At step 216, the UE 100 determines based on conditions, signalling, or a combination thereof whether to continue in the RRC_INACTIVE state. At step 218, the UE 100 configures and restores multicast MRB. At step 220, the multicast session is activated in the RRC_INACTIVE state. Further, step 222 represents multicast group notification conveying ‘session deactivation’. At step 224, the UE 100 releases the MRB and may inform upper layer about activation and/or TMGI. Further, the UE 100 continues monitoring group paging. When UE 100 receives group notification for “deactivation” in the RRC_INACTIVE state at step 226, the UE 100 stops receiving multicast and may release the multicast MRB, however, the UE 100 may retain the MRB configuration. Further, UE 100 may inform upper layer about deactivation and/or TMGI.

In an embodiment, table 6 discloses the deactivation notification to illustrate the procedure of paging message reception and handling by the UE 100.

TABLE 6
Upon receiving the Paging message, the UE shall:
<Unchanged Text Omitted>

| 1> | for each TMGI included in pagingGroupList, if any, included in the Paging | |
|---|---|---|
| | message: | |
| | 2> | if the UE has joined an MBS session indicated by the TMGI included in the |
| | | pagingGroupList: |
| | | 3> forward the TMGI to the upper layers; |
| 2> | if in RRC_INACTIVE and the UE has joined one or more MBS session(s) | |
| | indicated by the TMGI included in the pagingGroupList; and | |
| 1> | if none of the ue-Identity included in any of the PagingRecord, if included in the | |
| | Paging message, matches the UE identity allocated by upper layers; and | |
| 1> | if UE is not capable or is not configured or is not receiving multicast in | |
| | RRC_INACTIVE state: | |
| 3> | initiate the RRC connection resumption procedure according to 5.3.13 with | |
| | resumeCause set as below: | |
| 4> | if the UE is configured by upper layers with Access Identity 1: | |
| | | 4> resumeCause is set to mps-PriorityAccess; |
| 5> | else if the UE is configured by upper layers with Access Identity 2: | |
| | | 4> resumeCause is set to mcs-PriorityAccess; |
| 6> | else if the UE is configured by upper layers with one or more Access Identities | |
| | equal to 11-15: | |
| | | 4> resumeCause is set to highPriorityAccess; |
| 7> | else: | |
| | | 4> resumeCause is set to mt-Access. |
| 8> | else, if UE is capable and/or is configured and/or is receiving multicast session in | |
| | RRC_INACTIVE state and groupPagingCause and/or groupNotificationCause as | |
| | “deactivation” is indicated for the TMGI: | |
| | 2> | UE stops receiving the multicast session in the RRC_INACTIVE state; |
| | 2> | UE continues monitoring for group paging and/or group notification of (e.g., |
| | | activation and/or release) the multicast session(s) indicated by TMGI in the |
| | | RRC_INACTIVE state. |

FIG. 2B illustrates a flow diagram for performing a group notification or a group paging when UE 100 receive at least one of session activation and session deactivation notifications, according to an embodiment of the present disclosure. As explained with respect to FIG. 1, the group paging cause values indicate session activation, deactivation, modification, or release via the group paging message.

FIG. 2B illustrates the process of performing the group paging for UEs configured and capable of receiving multicast session in a Radio Resource Control (RRC)_INACTIVE state.

As illustrated in FIG. 2B, the MBS multicast session is active in the RRC-connected state at step 228. Further, at step 230, the network 108 transmits the RRC Release with SuspendConfig message to the UE 100. At step 232, the UE 100 transits to the RRC_INACTIVE state. At step 234, the UE 100 receives multicast in the RRC_INACTIVE state. Further, the UE 100 which is receiving multicast in the RRC_INACTIVE state, receives group notification conveying “session deactivation” in the RRC_INACTIVE state at step 236. Furthermore, step 238 represents the group paging with the first list, the second list, the common list, or any combination thereof for UEs that are capable or are configured to receive multicast in the RRC_INACTIVE state. At step 240, the UE 100 stops receiving multicast and may release the multicast MRB, however, UE 100 may retain the MRB configuration. In an embodiment of the present disclosure, the UE 100 stores the MRB configuration. Further, the UE 100 may inform upper layer about deactivation and/or TMGI. The UE 100 continues monitoring of the group paging. Step 242 represents deactivation of the multicast session. Further, step 244 represents the group notification for “activation” received by the UE 100. At step 246, the UE 100 configures or restores the multicast MRB configuration. Multicast MRB configuration may also be the one provided to the UE 100 during transition to RRC_INACTIVE state (e.g., through RRC Release with SuspendConfig message). Further, the UE 100 starts receiving multicast session in the RRC_INACTIVE state. This may be based on a determination or signalling whether to continue in the RRC_INACTIVE state. Further, the UE 100 may inform upper layer about activation and/or TMGI and continue monitoring group paging. Further, step 248 represents that the multicast session is active.

FIG. 3A illustrates a flow diagrams for performing a group notification or a group paging when UEs receive at least one of session activation and session release notifications, according to an embodiment of the present disclosure. As explained with respect to FIG. 1, the group paging cause values indicate session activation, deactivation, modification, or release via the group paging message. table 7 indicates release notification indicating reception of the paging message by the UE 100.

TABLE 7
Upon receiving the Paging message, the UE shall:
<Unchanged Text Omitted>

| | |
|---|---|
| 9> | for each TMGI included in pagingGroupList, if any, included in the Paging |
| | message: |
| 10> | if the UE has joined an MBS session indicated by the TMGI included in the |
| | pagingGroupList: |
| 11> | forward the TMGI to the upper layers; |
| 12> | if in RRC_INACTIVE and the UE has joined one or more MBS session(s) |
| | indicated by the TMGI included in the pagingGroupList; and |
| 2> | if none of the ue-Identity included in any of the PagingRecord, if included in the |
| | Paging message, matches the UE identity allocated by upper layers; and |
| 2> | if UE is not capable or is not configured or is not receiving multicast in |
| | RRC_INACTIVE state: |
| 13> | initiate the RRC connection resumption procedure according to 5.3.13 with |
| | resumeCause set as below: |
| 14> | if the UE is configured by upper layers with Access Identity 1: |
| 15> | resumeCause is set to mps-PriorityAccess; |
| 16> | else if the UE is configured by upper layers with Access Identity 2: |
| 17> | resumeCause is set to mcs-PriorityAccess; |
| 18> | else if the UE is configured by upper layers with one or more Access Identities |
| | equal to 11-15: |
| 19> | resumeCause is set to highPriorityAccess; |
| 20> | else: |
| 21> | resumeCause is set to mt-Access. |
| 22> | else, if UE is capable and/or is configured and/or is receiving multicast in |
| | RRC_INACTIVE state and groupPagingCause and/or groupNotificationCause as |
| | “release” is indicated for the TMGI: |
| | 2>UE stops receiving the multicast session in the RRC_INACTIVE state; |
| | 2>UE stops monitoring for group paging and/or group notification for the |
| | multicast session(s) indicated by TMGI in the RRC_INACTIVE state. |

FIG. 3A illustrates the process of performing the group paging for UEs configured and capable of receiving multicast session in a Radio Resource Control (RRC)_INACTIVE state. As illustrated in FIG. 3A, multicast session is active in the RRC-connected state at step 302. Further, step 304 represents dedicated signalling. The network 108 transmits RRC configuration with MRB release conveying session deactivation. Further, at 306, the multicast session is deactivated. Furthermore, at step 308, the network 108 transmits RRC Release with SuspendConfig message. At step 310, the UE 100 transits to the RRC_INACTIVE state.

Further, the UE 100 is capable and/or configured to receive multicast in RRC_INACTIVE state and group notification for “activation” in the RRC_INACTIVE state, at step 312. The group notification conveys session activation, RRC state, congestion status, or any combination thereof. In an embodiment, at least one of ‘activation’, ‘deactivation’, ‘modification’ and ‘release’ for multicast session may be implied or explicitly indicated by the group notification. In an embodiment, an example specification text is provided to illustrate the procedure of paging message reception and handling by the UE 100. table 8 indicates paging message carrying implicit or explicit “activation” related indication in group paging. In an embodiment of the present disclosure, step 314 represents the group paging with the first list, the second list, the common list, or any combination thereof for UEs capable or configured to receive multicast in the RRC_INACTIVE state. Further, multicast MRB configuration may also be the one provided to the UE 100 during transition to the RRC_INACTIVE state (e.g., through RRC Release with SuspendConfig message). Further, the UE 100 starts receiving multicast session in the RRC_INACTIVE state. At step 316, the UE 100 determines based on conditions, signalling, or a combination thereof whether to continue in the RRC_INACTIVE state. At step 318, the UE 100 configures and restores the multicast MRB. At step 320, the multicast session is activated in the RRC_INACTIVE state. Further, step 322 represents multicast group notification conveying ‘session deactivation’. At step 324, the UE 100 releases the MRB and may inform upper layer about activation and/or TMGI. The UE 100 which is capable and/or configured to receive multicast in the RRC_INACTIVE state and is in the RRC_INACTIVE state, the UE 100 monitors the group paging for the TMGI for which group paging cause as one of ‘activation’, ‘deactivation’, ‘modification’ and ‘release’ may be received. If the UE 100 is already receiving the multicast session for this TMGI actively in the RRC_INACTIVE state, the UE 100 continues monitoring the group paging for the TMGI for which group paging cause as ‘deactivation’, ‘modification’ or ‘release’ may be received. The UE 100 may indicate the ‘activation’, ‘deactivation’, ‘modification’, ‘release’ status, TMGI, or any combination thereof to the upper layers.

TABLE 8
Upon receiving the Paging message, the UE shall:

| | |
|---|---|
| 23> | if in RRC_IDLE, for each of the PagingRecord, if any, included in the |
| | Paging message: |
| 24> | if the ue-Identity included in the PagingRecord matches the UE identity |
| | allocated by upper layers: |
| 25> | if upper layers indicate the support of paging cause: |
| 26> | forward the ue-Identity, accessType (if present) and paging cause (if |
| | determined) to the upper layers; |
| 27> | else: |
| 28> | forward the ue-Identity and accessType (if present) to the upper layers; |
| 29> | if in RRC_INACTIVE, for each of the PagingRecord, if any, included in |
| | the Paging message: |
| 30> | if the ue-Identity included in the PagingRecord matches the UE's stored |
| | fullI-RNTI: |
| 31> | if the UE is configured by upper layers with Access Identity 1: |
| 32> | initiate the RRC connection resumption procedure according to 5.3.13 with |
| | resumeCause set to mps-PriorityAccess; |
| 33> | else if the UE is configured by upper layers with Access Identity 2: |
| 34> | initiate the RRC connection resumption procedure according to 5.3.13 with |
| | resumeCause set to mcs-PriorityAccess; |
| 35> | else if the UE is configured by upper layers with one or more Access |
| | Identities equal to 11-15: |
| 36> | initiate the RRC connection resumption procedure according to 5.3.13 with |
| | resumeCause set to highPriorityAccess; |
| 37> | else: |
| 38> | initiate the RRC connection resumption procedure according to 5.3.13 with |
| | resumeCause set to mt-Access; |
| 39> | else if the ue-Identity included in the PagingRecord matches the UE |
| | identity allocated by upper layers: |
| 40> | if upper layers indicate the support of paging cause: |
| 41> | forward the ue-Identity, accessType (if present) and paging cause (if |
| | determined) to the upper layers; |
| 42> | else: |
| 43> | forward the ue-Identity and accessType (if present) to the upper layers; |
| 44> | perform the actions upon going to RRC_IDLE as specified in 5.3.11 with |
| | release cause ‘other’; |
| 45> | for each TMGI included in pagingGroupList, if any, included in the Paging |
| | message: |
| 46> | if the UE has joined an MBS session indicated by the TMGI included in the |
| | pagingGroupList: |
| 47> | forward the TMGI to the upper layers; |
| 48> | if in RRC_INACTIVE and the UE has joined one or more MBS session(s) |
| | indicated by the TMGI included in the pagingGroupList; and |
| 1> | if none of the ue-Identity included in any of the PagingRecord, if included |
| | in the Paging message, matches the UE identity allocated by upper layers; |
| | and |
| 1> | if UE is not capable or is not configured or is not signalled to receive |
| | multicast in RRC_INACTIVE state: |
| 49> | initiate the RRC connection resumption procedure according to 5.3.13 with |
| | resumeCause set as below: |
| 50> | if the UE is configured by upper layers with Access Identity 1: |
| 51> | resumeCause is set to mps-PriorityAccess; |
| 52> | else if the UE is configured by upper layers with Access Identity 2: |
| 53> | resumeCause is set to mcs-PriorityAccess; |
| 54> | else if the UE is configured by upper layers with one or more Access |
| | Identities equal to 11-15: |
| 55> | resumeCause is set to highPriorityAccess; |
| 56> | else: |
| 57> | resumeCause is set to mt-Access. |
| 1> | else, if UE is capable and/or is configured and/or is signalled to receive |
| | multicast in RRC_INACTIVE state (i.e., there is no groupPagingCause |
| | present that implicitly implying activation or a groupPagingCause is present |
| | indicating activation): |
| | 2>UE starts receiving the multicast session(s) in the RRC_INACTIVE state |
| | 2>UE stops monitoring for paging for activation of the multicast session(s) |
| | indicated by TMGI in the RRC_INACTIVE state |

FIG. 3B illustrates a flow diagram for performing a group notification or a group paging when UEs receive at least one of session activation and session release notifications, according to an embodiment of the present disclosure. As explained with respect to FIG. 1, the group paging cause values indicate session activation, deactivation, modification, or release via the group paging message. Example 7 indicates release notification indicating reception of the paging message by the UE 100.

FIG. 3B illustrates the process of performing the group paging for UEs configured and capable of receiving multicast session in a Radio Resource Control (RRC)_INACTIVE state. As illustrated in FIG. 3B, the multicast session is active in the RRC-connected state at step 326. Further, at step 328, the network 108 transmits the RRC Release with SuspendConfig message to the UE 100. At step 330, the UE 100 transits to the RRC_INACTIVE state. At step 332, the UE 100 receives multicast in the RRC_INACTIVE state. Further, the UE 100 which is receiving multicast in the RRC_INACTIVE state, receives group notification conveying “session release” in the RRC_INACTIVE state at step 334. Furthermore, step 336 represents the group paging with the first list, the second list, the common list, or any combination thereof for UEs capable or configured to receive multicast in the RRC_INACTIVE state. At step 338, the UE 100 release the MRB and may inform the upper layers. Further, the UE 100 stops monitoring the group paging.

FIG. 4A illustrates a flow diagrams for performing a group notification or a group paging when the UE 100 transitions to the RRC_CONNECTED state, according to an embodiment of the present disclosure. As explained with respect to FIG. 1, the congestionStatus-r18 indicates the congestion status at the network 108 and may also implicitly indicate if the UE 100 can transition to RRC_CONNECTED state or remain in RRC_INACTIVE state.

FIG. 4A illustrates the process of performing the group paging for UEs configured and capable of receiving multicast session in the RRC_INACTIVE state. As illustrated in FIG. 4A, the multicast session is active in the RRC_CONNECTED state at step 402. Further, step 404 represents dedicated signalling. The network 108 transmits the RRC configuration with MRB release conveying session deactivation. Further, at step 406, the multicast session is deactivated. Furthermore, at step 408, the network 108 transmits RRC Release with SuspendConfig message. At step 410, the UE 100 transits to the RRC_INACTIVE state.

Further, the UE 100 is capable and/or configured to receive multicast in the RRC_INACTIVE state and group notification for “activation” in the RRC_INACTIVE state, at step 412. The group notification conveys session activation, RRC state, congestion status, or any combination thereof. In an embodiment of the present disclosure, step 414 represents the group paging with the first list, the second list, the common list, or any combination thereof for Ues capable or configured to receive multicast in the RRC_INACTIVE state. Further, at step 416, the UE 100 determines based on conditions and/or signalling to transit to the RRC_CONNECTED state.

At step 418, the UE 100 transmits RRC resume request to the network 108. Further, at step 420, the network 108 transmits the RRC resume/setup. Step 422 represents dedicated signalling representing configuration or reconfiguration. Furthermore, at step 424, multicast session is activated.

In an embodiment of the present disclosure, upon getting the indication from lower layer (e.g., RRC) with release status of at least one relevant TMGI, upper layer (e.g., NAS) requests lower layer to stop monitoring of the group paging for the relevant TMGI. Further, the NAS is informed about the session release only once UE 100 goes to RRC_CONNECTED state or is already in RRC_CONNECTED state (e.g., through NAS signalling) and not through group paging. In this case, the UE 100 continues to monitor group paging indefinitely in the RRC_IDLE state or the RRC_INACTIVE state. Once the UE 100 transits to the RRC_CONNECTED state and the NAS is informed about the session release, it informs the lower layer (e.g., RRC). The lower layer (e.g., RRC) may release the MRB configuration, if there is any, for the relevant TMGI.

In an embodiment, the NAS is informed about the session release only once UE 100 goes to the RRC_CONNECTED state and not through group paging. Further, the network 108 may send unicast paging to the UE 100 to come to the RRC_CONENCTED state and then, performs release signalling with the NAS. Once NAS is informed about the session release, it informs the lower layer. The lower layer (e.g., RRC) may release the MBS radio bearer configuration, if there is any, for the relevant TMGI.

In an embodiment of the present disclosure, legacy group paging (i.e., Rel-17 group paging) can be used to resume UE 100 to the RRC_CONNECTED state.

Further, when the UE 100 is capable and/or configured to receive multicast in the RRC_INACTIVE state and is receiving MBS multicast data in the RRC_INACTIVE state, the UE 100 stops receiving the data for the TMGI for which group paging or notification cause set as ‘deactivation’ is received. The UE 100 indicates to NAS about the session deactivation and the Access Stratum (AS) layer releases the MRB configurations associated with the MBS session. When the session is activated again through a group paging or notification, the UE 100 transitions to RRC_CONNECTED state to receive the MRB configurations.

Alternatively, in another embodiment of the present disclosure, the AS layer may store or retain the configuration and release the MRBs associated with the MBS session. When the UE 100 receives a group paging message indicating the ‘activation’ of the MBS multicast session and explicitly or implicitly indicate that the UE 100 can continue in INACTIVE state to receive the multicast data without change in the stored or retained MRB configurations, the AS layer can establish the MRBs from the stored configurations. In an embodiment present disclosure, the MRB configuration may be provided in the RRC_INACTIVE state, to continue the reception of the activated multicast session in the RRC_INACTIVE.

In an embodiment of the present disclosure, the indication to store or release the configuration can be signalled by the network 108 as part of group paging notification. Further, the MRB configurations for at least one multicast session reception in the RRC_INACTIVE state is provided to the UE 100 thorough the RRC Release with SuspendConfig message while UE 100 was getting released to the RRC_INACTIVE state. The UE 100 retains the multicast MRB configurations and utilize same in the RRC_INACTIVE state to continue receiving multicast. Further, when the multicast session is deactivated and is in the RRC_INACTIVE state, and the UE 100 receives group paging or group notification for activation, the UE 100 can utilize these MRB configurations to receive activated multicast session in the RRC_INACTIVE state.

FIG. 4B illustrates a flow diagram for performing a group notification or a group paging when the UE 100 transitions to the RRC_CONNECTED state, according to an embodiment of the present disclosure. As explained with respect to FIG. 1, the congestionStatus-r18 indicates the congestion status at the network 108 and may also implicitly indicate if the UE 100 can transition to RRC_CONNECTED state or remain in RRC_INACTIVE state.

FIG. 4B illustrates the process of performing the group paging for Ues configured and capable of receiving multicast session in the RRC_INACTIVE state. As illustrated in FIG. 4B, the multicast session is active in RRC-connected state 426. Further, at 428, the network 108 transmits RRC Release with SuspendConfig message. At 430, the UE 100 transmits to the RRC_INACTIVE state. Further, the UE 100 is capable and/or configured to receive multicast in the RRC_INACTIVE state and group notification for “activation” in the RRC_INACTIVE state, at steps 432 and 434. The group notification conveys session deactivation. In an embodiment of the present disclosure, step 436 represents the group paging with the first list, the second list, the common list, or any combination thereof for UEs capable or configured to receive multicast in the RRC_INACTIVE state. Further, at step 438, the UE 100 releases the MRB and store the MRB configuration. The UE 100 may also inform upper layers and continues monitoring the group paging. At step 440, the multicast session is deactivated. At step 442, the network 108 transmits a multicast group notification to the UE 100 conveying the session activation, the RRC state, the congestion status, or any combination thereof. At step 444, the UE 100 determines based on the conditions, the signalling, or a combination thereof that the UE 100 is required to transit to the RRC_CONNECTED state. At step 446, the UE 100 transmits RRC resume request to the network 108. Further, at step 448, the network 108 transmits the RRC resume/setup. step 450 represents dedicated signalling representing configuration or reconfiguration. Furthermore, at step 452, multicast session is activated in the RRC_CONNECTED state.

In an embodiment, when the UE 100 in the RRC_INACTIVE state, receives the CN paging and multicast session group notification (i.e., group paging) in the same paging message, the UE 100 (e.g., RRC) forwards the UE 100 identity and accessType (if present) in a paging record. In an embodiment of the present disclosure, the UE 100 identity included in the paging record matches the UE 100 identity allocated by upper layers. The UE 100 also forwards the TMGI which the UE 100 has joined and indicated in the pagingGroupList in the paging message. Further, UE 100 transitions to the RRC_IDLE state. In an embodiment of the present disclosure, UE NAS triggers service request to respond for CN paging. In an alternate embodiment of the present disclosure, the UE NAS ignores the CN paging and may instruct UE 100 to handle multicast session group notification and UE 100 handles the group paging. For example, the UE ignores CN paging (receiving CN paging in the RRC INACTIVE by the UE is a possible state mismatch scenario between the UE and network) and proceeds with handling of group paging. In case of conflict of CN paging and group paging in same paging message, the conflict is addressed based on the priority or criticality of the service(s) (e.g., access category/access identities/paging cause). For example, when group paging is for critical service e.g., mission critical push-to-talk (MCPTT), the UE 100 may respond to group paging and may receive the multicast session in the RRC_INACTIVE state or resume the RRC connection, and receive multicast session in the RRC_CONNECTED state.

In an embodiment, the processing of the paging message is completed fully i.e., for all the paging records and the pagingGroupList(s), before the UE 100 performs the transition to the RRC_IDLE state. The transition to RRC_IDLE state is performed when the UE 100 is in the RRC_INACTIVE state and receives CN paging and multicast session group notification (i.e., group paging) in the same paging message. When the UE 100 is in the RRC_INACTIVE state and receives RAN paging and multicast session group notification (i.e., group paging) in the same paging message, the UE 100 forwards the at least one of the TMGI which UE 100 has joined and indicated in the pagingGroupList in the paging message. Further, the UE 100 initiates the RRC connection resumption procedure. The UE 100 transmits a RRCResumeRequest or RRCResumeRequest1 message with a resumeCause which may be set in accordance with Access Identity configured by the upper layer.

Further, when the UE 100 is in the RRC_INACTIVE state and receives the RAN paging and multicast session group notification (i.e., group paging) in the same paging message, the UE 100 forwards the at least one of the TMGI which UE 100 has joined and indicated in the pagingGroupList in the paging message. Further, the UE 100 stays in the RRC_INACTIVE state and start receiving multicast session, if activation for multicast session is implicitly or explicitly indicated. That is, the UE 100 does not send a RRCResumeRequest or RRCResumeRequest1 message.

In an embodiment of the present disclosure, when the UE 100 is in the RRC_INACTIVE state and receives the RAN paging and multicast session group notification (i.e., group paging) in the same paging message, a determination to continue in the RRC_INACTIVE state or transit to the RRC_CONNNECTED state with RRC connection resumption is based on the indication of the RRC state to receive multicast session and/or “modification” of the multicast session configuration as indicated in the group notification message. In an alternate embodiment of the present disclosure, this determination is based on the priority of the unicast and multicast, the congestion status indicated, the RRC state indicated in group paging message, QoS requirement of the multicast session, location of the UE 100 (e.g., near to cell edge or closer to gNB), signal strength or channel conditions as configured by network 108 (e.g., certain channel condition thresholds like Block Error Rate (BLER), Signal to Interference & Noise Ratio (SINR), Reference Signal Received Power (RSRP), Channel Quality Indicator (CQI) and/or measured by UE 100, presence or absence other PDU session(s) or connection initiation for unicast services, UE 100 priority, MBS session priority, and the like. For example, if multicast is prioritized, the UE 100 may continue in the RRC_INACTIVE state. Further, if unicast is prioritized, the UE 100 may transit to the RRC_CONNECTED state as illustrated in FIG. 4A and FIG. 4B.

FIG. 5 illustrates a flow chart depicting an operation of the UE 100 for managing the one or more MBS multicast sessions in RRC_INACTIVE, according to an embodiment of the present disclosure. As explained with respect to FIG. 1, one or more processors 102 of the UE 100 changes the session status of the one or more MBS multicast sessions, the RRC state, the MBS multicast session configuration, or a combination thereof based on the received group notification message for managing the one or more MBS multicast sessions. FIG. 5 depicts a process implemented by the UE 100 configured and/or capable of receiving multicast session in the RRC_INACTIVE state message for managing the one or more MBS multicast sessions.

In an embodiment of the present disclosure, at step 502, it is determined that the UE 100 is capable and/or configured to receive multicast in RRC_INACTIVE state. At step 504, it is determined if the UE 100 has joined the one or more MBS multicast sessions which are non-activated i.e., not activated or deactivated after activation. If yes, at step 506, the UE 100 monitors paging for group notification for multicast sessions with the associated MBS session ID or TMGI on the unicast paging occasions. If the output of step 504 is no, the UE 100 does not monitor for the group notification on the unicast paging occasions at step 508. At step 510, it is determined if the group notification indicates activation. If yes, the UE 100 configures, restores, or a combination thereof multicast MRB and may inform upper layers at step 512. Further, the UE 100 starts receiving multicast in RRC_INACTIVE state. If the output of step 510 is no, at step 514 it is determined if the group notification indicates release. If yes, at step 516, the UE 100 releases the MRB and informs the upper layers. The UE 100 stops monitoring the paging. In an embodiment, the UE 100 which is capable and/or configured to receive multicast in RRC_INACTIVE state and is in the RRC_INACTIVE state, starts receiving multicast for the TMGI for which group paging cause as ‘activation’ is received. The UE 100 may indicate the activation status and/or TMGI to the upper layers. While the UE 100 may continue to monitor the group paging. If the UE 100 was receiving the multicast session for this TMGI, UE 100 abandons receiving multicast session for the TMGI for which group paging cause as ‘deactivation’ is received. UE 100 may indicate the deactivation status and/or TMGI to the upper layers. While the UE 100 may continue to monitor the group paging.

Further, at step 518, it is determined if UE 100 is receiving multicast session in RRC_INACTIVE state. If yes, the UE 100 monitors paging for group notification for multicast session with the associated MBS session ID or TMGI on the unicast paging occasions at step 520. If the output of step 518 is no, the UE 100 does not monitor for group notification on the unicast paging occasions at step 522. At step 524, it is determined if the group notification indicates deactivation. If yes, the UE 100 stops monitoring receiving the multicast and releases the MRB at step 526. The UE 100 also informs the upper layers and continues monitoring the group paging. If the output of the step 524 is no, it is determined whether the group notification indicates release at step 528. If yes, at step 530, the UE 100 in the RRC_INACTIVE state, stops monitoring the group paging for the TMGI for which group paging cause as ‘release’ is received. If the UE 100 was receiving the multicast session for this TMGI, UE 100 abandons receiving multicast session and releases the multicast MBS Radio Bearer (MRB). UE 100 may indicate the release status and/or TMGI to the upper layers. While UE 100 may continue to monitor the group paging for other relevant TMGI(s), if any as depicted in FIG. 5. In an embodiment of the present disclosure, an example specification text (table 9) is provided to illustrate the procedure of paging message reception and handling by the UE 100. table 9 discloses the group paging with cause.

TABLE 9
Upon receiving the Paging message, the UE shall:
<Unchanged Text Omitted>

| 1> | for each TMGI included in pagingGroupList, if any, included in | |
|---|---|---|
| | the Paging message: | |
| 2> | if the UE has joined an MBS session indicated by the TMGI included in | |
| | the pagingGroupList: | |
| 3> | forward the TMGI to the upper layers; | |
| 4> | if the paging message includes a group paging cause for the TMGI indicated | |
| | in pagingGroupList | |
| 5> | if the groupPagingCause is indicated as session release: | |
| | | 5> if UE is receiving multicast data for that session, the UE stops the |
| | | data reception |
| | | 5> stop monitoring group paging for that session |
| | | 5> indicate to upper layer regarding the release of the session |
| 6> | if the groupPagingCause is indicated as session deactivation: | |
| | 5> | if UE is receiving multicast data for that session, the UE stops the data |
| | | reception |
| | | 5> indicate to upper layer regarding the deactivation of the session |

| | |
|---|---|
| 7> | if the groupPagingCause is indicated as session modicaition: |

5> if UE is in RRC_IDLE, indicate to upper layer regarding the

| | |
|---|---|
| | session modification notification |
| 8> | else, if there is no the groupPagingCause associated with the TMGI, |
| | consider the groupPagingCause is for session activation |
| 9> | if in RRC_INACTIVE and the UE has joined one or more MBS session(s) |
| | indicated by the TMGI included in the pagingGroupList; and |
| 10> | if none of the ue-Identity included in any of the PagingRecord, if included |
| | in the Paging message, matches the UE identity allocated by upper layers: |
| 11> | if UE is not capable or is not configured or is not signalled to receive |
| | multicast in RRC_INACTIVE state or the groupPagingCause for the TMGI |
| | indicates session modification: |
| 12> | initiate the RRC connection resumption procedure according to 5.3.13 |
| | with resumeCause set as below: |
| 13> | if the UE is configured by upper layers with Access Identity 1: |
| 14> | resumeCause is set to mps-PriorityAccess; |
| 15> | else if the UE is configured by upper layers with Access Identity 2: |
| 16> | resumeCause is set to mcs-PriorityAccess; |
| 17> | else if the UE is configured by upper layers with one or more Access |
| | Identities equal to 11-15: |
| 18> | resumeCause is set to highPriorityAccess; |
| 19> | else: |
| 20> | resumeCause is set to mt-Access. |
| 21> | else, if the UE is capable and/or is configured and/or is signalled to receive |

```
    multicast in RRC_INACTIVE state (i.e., groupPagingCause is indicated as
    activation):
```

| | |
|---|---|
| 22> | start receiving the multicast session in RRC_INACTIVE state |

FIG. 6 illustrates an operational flow diagram depicting an operation of the UE 100 for managing the one or more MBS multicast sessions, according to an embodiment of the present disclosure. As explained with respect to FIG. 1, one or more processors 102 of the UE 100 changes the session status of the one or more MBS multicast sessions, the RRC state, the MBS multicast session configuration, or a combination thereof based on the received group notification message for managing the one or more MBS multicast sessions.

At step 602, the UE 100 is in RRC_CONNECTED state and is receiving multicast session X, Y and Z (i.e., session X, Y and Z are in activated state). Further, at step 604, the UE 100 receives dedicated signaling from the network 108 i.e., a RRC reconfiguration message with MRB release conveying “session deactivation” for session Y. The UE 100 releases the MRB for session Y. Session Y is now in a deactivated state. At step 606, the multicast session X and Z are in activated state. Further, at step 608, the UE 100 receives RRC Release with SuspendConfig that carries the configuration for session X and Y to be continued in the RRC_INACTIVE state. The UE 100 suspends session Z. Furthermore, the UE 100 stores configuration for session Y. At step 610, the UE 100 transits to RRC_INACTIVE state from RRC_CONNECTED state. At step 612, the UE 100 monitors the group notification for session Y for activation (or other events) and session Y for deactivation (or other events). In an exemplary embodiment of the present disclosure, other events may include release, RRC state change, configuration change, congestion indication, or the like.

At step 614, the UE 100 receives multicast group notification (e.g., group paging) conveying session Y activation and other events. Further, the group paging may be provided as a common list, the first list or the second list for legacy UEs (i.e., UEs that do not support multicast reception in RRC_INACTIVE state) and the UE 100 capable or configured to receive multicast reception in RRC_INACTIVE state. The UE 100 determines based on channel condition (e.g., poor signal conditions) and/or signaling (e.g., RRC state is indicated as RRC_CONNECTED state in group paging) to continue in RRC_INACTIVE state or go to RRC_CONNECTED state. Further, at step 616, the UE 100 configures and restores the multicast MRB for session Y if the UE 100 is in RRC_INACTIVE state. Now session X and Y are active in RRC_INACTIVE state. At step 618, the UE 100 receives multicast group notification (e.g., group paging) conveying session X deactivation. The UE 100 releases the MRB for session X and may inform upper layers. Further, the UE 100 continues monitoring group notification for session X for possible activation (or other events).

At step 620, the UE 100 receives multicast group notification (e.g., group paging) conveying session Y release. The UE 100 releases the MRB for session Y and may inform upper layers. The UE 100 stops monitoring group notification for session Y. Further, at step 622, the UE 100 receives multicast group notification (e.g., group paging) conveying session X activation, other events, or a combination thereof. The UE 100 determines based on channel condition (e.g., poor signal conditions), signaling (e.g., RRC state is indicated as RRC_CONNECTED state in group paging) to continue in RRC_INACTIVE state, or go to RRC_CONNECTED state. At step 624, the UE sends a RRC Resume Request to the network 108 when the UE continues in RRC_CONNECTED. At step 626, the UE 100 receives RRC Resume or setup message from the network 108 and the UE 100 transits to RRC_CONNECTED state.

At step 628, in RRC_CONENCTED state, the UE 100 receives dedicated signaling from the network 108 i.e., a RRC reconfiguration message with MBS radio bearer (MRB) setup conveying “session activation” for session X. Further, at step 630, multicast session X is now active in RRC_CONNECTED state.

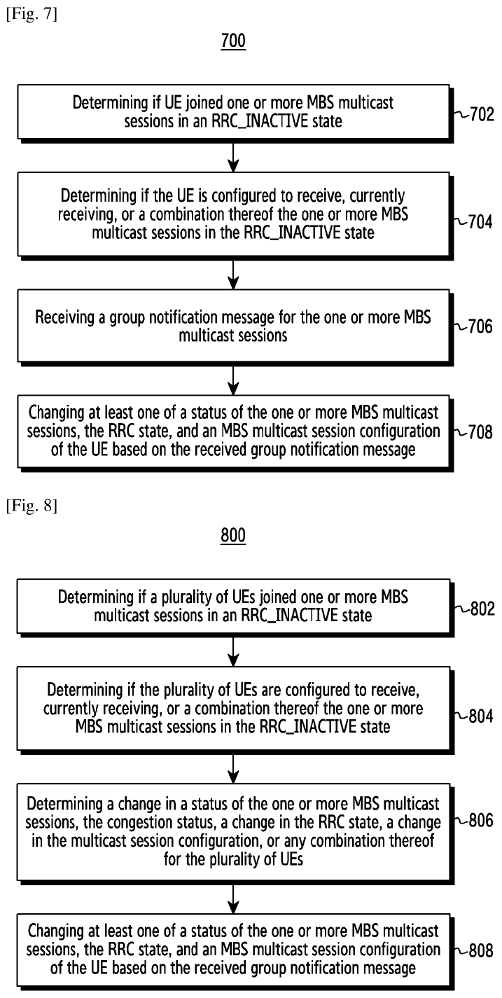

FIG. 7 is a flow diagram illustrating a method for managing the one or more MBS multicast sessions in a User Equipment (UE), in accordance with an embodiment of the present disclosure. In an embodiment of the present disclosure, the method 700 is performed by the UE by using the one or more processors 102, as illustrated in FIG. 1.

At step 702, the method 700 includes determining if the UE joined one or more MBS multicast sessions in a Radio Resource Control (RRC)_INACTIVE state.

At step 704, the method 700 includes determining if the UE 100 is configured to receive, currently receiving, or a combination thereof the one or more MBS multicast sessions in the RRC_INACTIVE state upon determining that the UE has joined the one or more MBS multicast sessions.

At step 706, the method 700 includes receiving a group notification message for the one or more MBS multicast sessions upon determining that the UE 100 is configured to receive, currently receiving, or a combination thereof the one or more MBS multicast sessions in the RRC_INACTIVE state. In an embodiment of the present disclosure, the group notification message includes an identity corresponding to at least one of the one or more MBS multicast sessions, a session status, an indication of Radio Resource Control (RRC) state, a congestion status, a change of MBS multicast session configuration, or any combination thereof. In an exemplary embodiment of the present disclosure, the one or more MBS multicast sessions includes activated session, deactivated session, or a combination thereof. In receiving the group notification message, the method 700 includes receiving the group notification message via at least one of a group paging message or a Multicast MBS Control Channel (MCCH) message. In an embodiment of the present disclosure, the UE 100 is in an RRC_INACTIVE state and receives an MBS multicast session in the RRC_INACTIVE state. In an exemplary embodiment of the present disclosure, the session status includes a session activation status, a session deactivation status, a session release status, and a session configuration modification status. The RRC state includes an RRC_CONNECTED state, and an RRC_INACTIVE state. In an embodiment of the present disclosure, the change of MBS multicast session configuration includes the indication of the change of MBS multicast session configuration, an updated MBS multicast session configuration, or a combination thereof.

In receiving the group notification message via the group paging message, the method 700 includes receiving the group paging message in each of a first list and a second list. In an embodiment of the present disclosure, the first list is received for first group of the one or more MBS multicast sessions that are not configured to be received in the RRC_INACTIVE state and the second list is received for a second group of the one or more MBS multicast sessions that are configured to be received in RRC_INACTIVE state. In an embodiment of the present disclosure, the first list and the second list are a common list including a session id for each of the group paging message to identify of a type of the one or more MBS multicast sessions.

At step 708, the method 700 includes changing a session status of the one or more MBS multicast sessions, the RRC state, an MBS multicast session configuration of the UE 100, or any combination thereof based on the received group notification message.

When the UE 100 is in the RRC_INACTIVE state, a session modification configuration of the one or more MBS multicast sessions received in the group notification message is stored. Further, the configuration of the one or more MBS multicast sessions is updated based on the stored session modification configuration.

Further, the NAS layer of one or more multicast MBS sessions release is informed via a NAS signalling, when the UE 100 is in an RRC_CONNECTED state. In an embodiment of the present disclosure, the one or more MBS multicast sessions release is determined based on a removal of the MBS multicast session configuration in the group notification message when the UE 100 is in the RRC_INACTIVE state. The one or more MBS multicast sessions release is indicated in the group notification message when the UE 100 is in the RRC_INACTIVE state.

Further, the RRC state of the UE 100 is switched from an RRC_CONNECTED state to an RRC_INACTIVE state based on a configuration for at least one multicast session reception in the RRC_INACTIVE state. In an embodiment of the present disclosure, the configuration is received via an RRCRelease with suspendConfig message. The multicast reception is continuously received upon switching to the RRC_INACTIVE state. The MBS multicast session is in an activated state. Further, the group notification message is continuously monitored for the MBS multicast session upon switching to the RRC_INACTIVE state.

Further, the RRC state of the UE 100 is switched from an RRC_ INACTIVE state to an RRC_CONNECTED state based on the group notification message upon achieving one or more conditions. In an embodiment of the present disclosure, the one or more conditions include absence of an RRC state field in the group notification message, an RRC state field including RRC_CONNECTED state, the group notification message indicating the one or more MBS multicast session not configured to be received in an RRC_INACTIVE state, or any combination thereof. Further, multicast reception of data is received upon switching to the RRC_CONNECTED state.

Furthermore, an occurrence of one or more first events is determined based on the received group notification message. In an embodiment of the present disclosure, the one or more first events include session activation, resumption of data transmission, or a combination thereof. Further, a Group-Radio Network Temporary Identifier (G-RNTI) or Group-Configured Scheduled Radio Network Temporary Identifier (G-CS-RNTI) is monitored upon determining the occurrence of the one or more first events. The UE 100 remains in an RRC_INACTIVE state.

Further, an occurrence of one or more second events is determined based on the received group notification message. In an exemplary embodiment of the present disclosure, the one or more second events include session deactivation, temporary no data availability, or a combination thereof. Further, the G-RNTI or the G-CS-RNTI is not monitored upon determining the occurrence of the one or more second events. The UE 100 remains in an RRC_INACTIVE state.

Further, it is determined if both unicast paging and group paging/group notification is received by the UE 100 in the RRC_INACTIVE state in the same paging message. In an embodiment of the present disclosure, the unicast paging corresponds to a Radio Access Network (RAN) paging. Further, the group paging corresponds to a multicast session configured to be received in RRC_INACTIVE state. The unicast paging is executed via the UE 100. Furthermore, the RRC state of the UE 100 is switched to an RRC_CONNECTED state upon executing the unicast paging. In an exemplary embodiment of the present disclosure, the unicast paging includes Radio Access Network (RAN) paging, Core Network (CN) paging, or a combination of thereof.

Furthermore, a multicast is received in an RRC_INACTIVE state by applying a Point-To-Multipoint (PTM) configuration, when an MBS multicast session is activated. In an embodiment of the present disclosure, the UE 100 stores the PTM configuration before the MBS multicast session is activated. Further, the UE 100 receives the multicast by applying the PTM configuration. In an embodiment of the present disclosure, the UE 100 receives the PTM configuration for the activated MBS multicast session via an RRCRelease message with suspendconfig, a group notification message, or a combination thereof.

When the network 108 configures the UE 100 to continue the multicast reception in the INACTIVE state, the network 108 provides the PTM configuration for the activated multicast session via the RRC dedicated signalling, at least for the serving cell. In an embodiment of the present disclosure, the multicast MCCH is used in case there is a requirement to indicate a PTM configuration and a requirement for change in the PTM configuration in the RRC_INACTIVE or during mobility beyond serving cell/gNB.

In an embodiment of the present disclosure, if PTM configuration is not available to the UE 100 upon occurrence of events, such as session activation/data transmission resumed, the UE 100 initiates RRC connection resumption.

Further, the one or more MBS multicast sessions are continued in an RRC_INACTIVE state if the RRC state is present in the group notification message and the RRC state is not an RRC_CONNECTED state, or the group notification message is received for the one or more MBS multicast sessions that are configured to be received in the RRC_INACTIVE state. Further, UE 100-specific paging (i.e., PagingRecordList) can be used to move specific MBS multicast UE(s) to RRC_CONNECTED (i.e., legacy UE 100 behaviour).

FIG. 8 is a flow diagram illustrating a method for managing the one or more MBS multicast sessions in a plurality of UEs, in accordance with an embodiment of the present disclosure. In an embodiment of the present disclosure, the method 800 is performed by a network 108 by using the one or more processors 110, as depicted in FIG. 1.

At step 802, the method 800 includes determining if a plurality of UEs joined the one or more MBS multicast sessions.

At step 804, the method 800 includes determining if the plurality of UEs is configured to receive, currently receiving, or a combination thereof the one or more MBS multicast sessions in the RRC_INACTIVE state upon determining that the plurality of UEs joined the one or more MBS multicast sessions.

At step 806, the method 800 includes determining a change in a session status of the one or more MBS multicast sessions, the congestion status, a change in the RRC state, a change in the multicast session configuration, or any combination thereof for the plurality of UEs upon determining that the plurality of UEs are configured to receive, currently receiving, or a combination thereof the one or more MBS multicast sessions in the RRC_INACTIVE state.

At step 808, the method 800 includes transmitting the group notification message to the plurality of UEs for the one or more MBS multicast sessions upon determining the change in the session status of the one or more MBS multicast sessions, the congestion status, the change in the RRC state, the change in the multicast session configuration, or any combination thereof. In transmitting the group notification message via the group paging message, the method 800 includes transmitting the group paging message in each of the first list and the second list. In an embodiment of the present disclosure, the first list and the second list are the common list including the session id for each of the group paging message to identify of a type of the one or more MBS multicast sessions.

While the above steps shown in FIG. 7 and FIG. 8 are described in a particular sequence, the steps may occur in variations to the sequence in accordance with various embodiments of the present disclosure. Further, the details related to various steps of FIG. 7 and FIG. 8, which are already covered in the description related to FIGS. 1-6 are not discussed again in detail here for the sake of brevity.

The present disclosure provides for various technical advancements based on the key features discussed above. Further, the present disclosure allows group paging for the UEs that are capable or configured to receive the NR MBS in the RRC_INACTIVE state. The present disclosure provides an approach to handle simultaneous reception of the CN paging and the group paging in the same paging message by the UE 100 in RRC_INACTIVE state. Further, the present disclosure provides an approach to handle simultaneous reception of the RAN paging and the group paging in the same paging message by the UE 100 in RRC_INACTIVE state. Furthermore, the present disclosure specifies the mechanism for group paging that can cater to different scenarios, events and causes for the signalling the Ues that can receive multicast in RRC_INACTIVE state. The present disclosure also specifies the mechanism for group paging for session activation, deactivation, release, state change, configuration change for a multicast session that can be received in RRC_INACTIVE state. Further, the group notification approach of the present disclosure enables multicast reception in RRC_INACTIVE state.

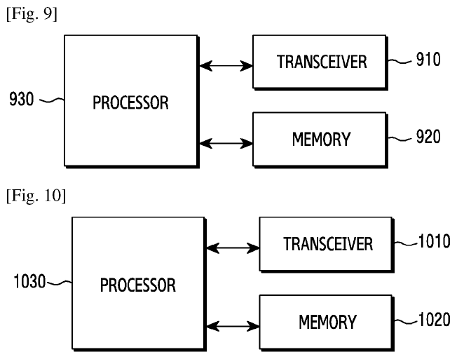

FIG. 9 illustrates a block diagram of a terminal (or a user equipment (UE)), according to embodiments of the present disclosure. FIG. 9 corresponds to the example of the UE of FIG. 1.

As shown in FIG. 9, the UE according to an embodiment may include a transceiver 910, a memory 920, and a processor 930. The transceiver 910, the memory 920, and the processor 930 of the UE may operate according to a communication method of the UE described above. However, the components of the UE are not limited thereto. For example, the UE may include more or fewer components than those described above. In addition, the processor 930, the transceiver 910, and the memory 920 may be implemented as a single chip. Also, the processor 930 may include at least one processor.

The transceiver 910 collectively refers to a UE receiver and a UE transmitter, and may transmit/receive a signal to/from a base station or a network entity. The signal transmitted or received to or from the base station or a network entity may include control information and data. The transceiver 910 may include a RF transmitter for upconverting and amplifying a frequency of a transmitted signal, and a RF receiver for amplifying low-noise and down-converting a frequency of a received signal. However, this is only an example of the transceiver 910 and components of the transceiver 910 are not limited to the RF transmitter and the RF receiver.

Also, the transceiver 910 may receive and output, to the processor 930, a signal through a wireless channel, and transmit a signal output from the processor 930 through the wireless channel.

The memory 920 may store a program and data required for operations of the UE. Also, the memory 920 may store control information or data included in a signal obtained by the UE. The memory 920 may be a storage medium, such as read-only memory (ROM), random access memory (RAM), a hard disk, a CD-ROM, and a DVD, or a combination of storage media.

The processor 930 may control a series of processes such that the UE operates as described above. For example, the transceiver 910 may receive a data signal including a control signal transmitted by the base station or the network entity, and the processor 930 may determine a result of receiving the control signal and the data signal transmitted by the base station or the network entity.

FIG. 10 illustrates a block diagram of a base station, according to embodiments of the present disclosure. FIG. 10 corresponds to the example of the network of FIG. 1.

As shown in FIG. 10, the base station according to an embodiment may include a transceiver 1010, a memory 1020, and a processor 1030. The transceiver 1010, the memory 1020, and the processor 1030 of the base station may operate according to a communication method of the base station described above. However, the components of the base station are not limited thereto. For example, the base station may include more or fewer components than those described above. In addition, the processor 1030, the transceiver 1010, and the memory 1020 may be implemented as a single chip. Also, the processor 1030 may include at least one processor.

The transceiver 1010 collectively refers to a base station receiver and a base station transmitter, and may transmit/receive a signal to/from a terminal or a network entity. The signal transmitted or received to or from the terminal or a network entity may include control information and data. The transceiver 1010 may include a RF transmitter for up-converting and amplifying a frequency of a transmitted signal, and a RF receiver for amplifying low-noise and down-converting a frequency of a received signal. However, this is only an example of the transceiver 1010 and components of the transceiver 1010 are not limited to the RF transmitter and the RF receiver.

Also, the transceiver 1010 may receive and output, to the processor 1030, a signal through a wireless channel, and transmit a signal output from the processor 1030 through the wireless channel.

The memory 1020 may store a program and data required for operations of the base station. Also, the memory 1020 may store control information or data included in a signal obtained by the base station. The memory 1020 may be a storage medium, such as read-only memory (ROM), random access memory (RAM), a hard disk, a CD-ROM, and a DVD, or a combination of storage media.

The processor 1030 may control a series of processes such that the base station operates as described above. For example, the transceiver 1010 may receive a data signal including a control signal transmitted by the terminal, and the processor 1030 may determine a result of receiving the control signal and the data signal transmitted by the terminal.

In the afore-described embodiments of the present disclosure, elements included in the present disclosure are expressed in a singular or plural form according to the embodiments. However, the singular or plural form is appropriately selected for convenience of explanation and the present disclosure is not limited thereto. As such, an element expressed in a plural form may also be configured as a single element, and an element expressed in a singular form may also be configured as plural elements.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

1-15. (canceled)

16. A method performed by a user equipment (UE) in a wireless communication system, the method comprising:
receiving, from a base station (BS), a radio resource control (RRC) release message including a suspend configuration, wherein the RRC release message further includes configuration information for a reception of a multicast and broadcast service (MBS) multicast in an RRC inactive state;
receiving, from the BS while the UE is in the RRC inactive state, a paging message including paging group information; and
receiving, from the BS while the UE is in the RRC inactive state, the MBS multicast of a multicast session based on the configuration information and the paging group information.

17. The method of claim 16, wherein the MBS multicast session is indicated by a temporary mobile group identity (TMGI) included in the paging group information.

18. The method of claim 16, further comprising:
transmitting, to the BS, an RRC resume message, in case that the UE is not able to receive the MBS multicast of the multicast session in the RRC inactive state.

19. The method of claim 16, wherein the paging message includes a first UE identity matching a second UE identity allocated by an upper layer, a temporary mobile group identity (TMGI) included in the paging group information is forwarded to the upper layer.

20. A user equipment (UE) in a wireless communication system, the UE comprising:
a transceiver, and
a controller coupled with the transceiver and configured to:
receive, from a base station (BS), a radio resource control (RRC) release message including a suspend configuration, wherein the RRC release message further includes configuration information for a reception of a multicast and broadcast service (MBS) multicast in an RRC inactive state,
receive, from the BS while the UE is in the RRC inactive state, a paging message including paging group information, and
receive, from the BS while the UE is in the RRC inactive state, the MBS multicast of a multicast session based on the configuration information and the paging group information.

21. The UE of claim 20,
wherein the MBS multicast session is indicated by a temporary mobile group identity (TMGI) included in the paging group information.

22. The UE of claim 20, wherein the controller is further configured to:
transmit, to the BS, an RRC resume message, in case that the UE is not able to receive the MBS multicast of the multicast session in the RRC inactive state.

23. The UE of claim 20,
wherein the paging message includes a first UE identity matching a second UE identity allocated by an upper layer, a temporary mobile group identity (TMGI) included in the paging group information is forwarded to the upper layer.

24. A method performed by a base station (BS) in a wireless communication system, the method comprising:
transmitting, to a user equipment (UE), a radio resource control (RRC) release message including a suspend configuration, wherein the RRC release message further includes configuration information for a reception of a multicast and broadcast service (MBS) multicast in an RRC inactive state;
transmitting, to the UE in the RRC inactive state, a paging message including paging group information; and
transmitting, to the UE in the RRC inactive state, the MBS multicast of a multicast session based on the configuration information and the paging group information.

25. The method of claim 24, wherein the MBS multicast session is indicated by a temporary mobile group identify (TMGI) included in the paging group information.

26. The method of claim 24, further comprising:
receiving, from the UE, an RRC resume message, in case that the UE is not able to receive the MBS multicast of the multicast session in the RRC inactive state.

27. The method of claim 24, wherein the paging message includes a first UE identity matching a second UE identity allocated by an upper layer, a temporary mobile group identity (TMGI) included in the paging group information is forwarded to the upper layer.

28. A base station (BS) in a wireless communication system, the BS comprising:
a transceiver, and
a controller coupled with the transceiver and configured to:
transmit, to a user equipment (UE), a radio resource control (RRC) release message including a suspend configuration, wherein the RRC release message further includes configuration information for a reception of a multicast and broadcast service (MBS) multicast in an RRC inactive state,
transmit, to the UE in the RRC inactive state, a paging message including paging group information, and
transmit, to the UE in the RRC inactive state, the MBS multicast of a multicast session based on the configuration information and the paging group information.

29. The BS of claim 28, wherein the multicast session is indicated by a temporary mobile group identify (TMGI) included in the paging group information.

30. The BS of claim 28, wherein the controller is further configured to:
receive, from the UE, an RRC resume message, in case that the UE is not able to receive the MBS multicast of the multicast session in the RRC inactive state.

31. The BS of claim 28, wherein the paging message includes a first UE identity matching a second UE identity allocated by an upper layer, a temporary mobile group identity (TMGI) included in the paging group information is forwarded to the upper layer.
